(19) United States
(12) Patent Application Publication
(10) Pub. No.: US 2026/0228255 A1
(43) Pub. Date: Aug. 6, 2026

(54) Systems and Methods for Obtaining Web Browser Context for a Large Language Model Prompt

(71) Applicant: Cisco Technology, Inc., San Jose, CA (US)

(72) Inventors: Umang Agarwal, Menlo Park, CA (US); Nasim Bigdelu, North Vancouver (CA); Kristal Curtis, San Francisco, CA (US); Liang Gou, San Jose, CA (US); Abhinav Mathur, Oakland, CA (US); Rehan Salman Mulla, Fremont, CA (US); Om Rajyaguru, San Diego, CA (US); Joseph Ari Ross, Redwood City, CA (US); Emily Yang, New York, NY (US)

(21) Appl. No.: 19/211,006

(22) Filed: May 16, 2025

Related U.S. Application Data
(60) Provisional application No. 63/753,401, filed on Feb. 3, 2025.

(51) Int. Cl. G06F 16/3329; G06F 16/338; H04L 51/02

(52) U.S. Cl. CPC G06F 16/33295; G06F 16/338; H04L 51/02

(57) ABSTRACT

One implementation is directed at implementations and deployment of an artificial intelligence (AI) Assistant in an inquiry session with a large language model (LLM). The disclosure provides for appending contextual information to a user input corresponding to a question to be evaluated by the LLM. The user input is received by a graphical user interface (GUI) of a network device of a user. The user input includes the question in the GUI. Contextual metadata are received from content displayed on a display screen of the network device. A prompt for the LLM is generated from the user input and the contextual metadata, and is provided to the LLM. A response is received from the LLM. An answer to the question is displayed in the GUI of the network device of the user.

### CROSS-REFERENCE TO RELATED APPLICATIONS

This application claims the benefit of priority to U.S. Provisional Application No. 63/753,401, filed on Feb. 3, 2025, the entire contents of which are incorporated herein by reference.

### FIELD

The present disclosure relates to artificial intelligence systems. More particularly, the present disclosure relates to optimizing one or more elements of large language models.

### BACKGROUND

Large Language Models (LLMs) have progressed from early language-processing techniques to become sophisticated AI systems reshaping digital communication and content creation. The journey of LLMs started with basic natural language processing (NLP) research in the mid-20th century, but modern models emerged only recently, as advancements in deep learning and neural networks took center stage. The transformer architecture marked a turning point for LLMs, as it allowed models to capture complex dependencies and context in text efficiently. Since their inception, LLMs have pushed the boundaries of language understanding and generation. However, the success of these models also relies heavily on GPU capabilities, which enable the parallel processing required to handle the massive datasets and billions, or even trillions of parameters. GPUs can provide the speed and computational power that allow LLMs to perform real-time language tasks, even as they grow increasingly complex.

Industries are integrating LLMs in varied ways to streamline operations, boost creativity, and enhance productivity, with applications ranging from customer service to software development and healthcare. Advanced AI agents powered by LLMs are becoming common, allowing businesses to manage customer interactions through natural language understanding, where these agents can handle complex inquiries and generate detailed responses. In creative fields, LLM-based AI agents assist with drafting content, suggesting ideas, and even composing music or visual captions, enhancing creative processes by providing inspiration and augmenting human creativity. In software development, AI agents can automate parts of the coding process, generating code snippets, detecting bugs, and maintaining documentation. Healthcare is also benefiting from LLMs, as AI agents assist in summarizing medical records and offering preliminary diagnostic support. However, as LLMs and AI agents support these diverse applications, the demand on GPUs and network infrastructure grows considerably. To manage these increasing loads, organizations often rely on high-capacity Network Interface Cards (NICs) with load-balancing and flow control, such as Queue Pair (QP) capacity, to efficiently manage data flow and distribute tasks across clusters. This network infrastructure becomes essential for scaling up LLM-based agents to handle real-time interactions and large user bases without sacrificing responsiveness.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a diagram depicting various subsets of artificial intelligence in accordance with various embodiments of the disclosure;

FIG. 2 depicts different methods of machine-based learning in accordance with various embodiments of the disclosure;

FIG. 3 depicts a machine learning lifecycle in accordance with various embodiments of the disclosure; and

FIG. 4 is an exemplary neural network for use in a fully controlled camera system in accordance with various embodiments of the disclosure.

FIG. 5 is a conceptual illustration of a variety of tokens for utilization within a large language model in accordance with various embodiments of the disclosure;

FIG. 6 is a conceptual illustration of an embedding matrix for a large language model, in accordance with various embodiments of the disclosure;

FIG. 7 is a conceptual illustration of an input prompt converted from a series of tokens into a series of tensors in accordance with various embodiments of the disclosure;

FIG. 8 is a conceptual illustration of an attention layer process within a large language model in accordance with various embodiments of the disclosure;

FIG. 9 is a conceptual illustration of a multi-layer perceptron within a large language model in accordance with various embodiments of the disclosure;

FIG. 10 is a conceptual illustration of an unembedding process within a large language model in accordance with various embodiments of the disclosure;

FIG. 11 is an example web page including a chat interface displayed in a web browser application on a networking device in accordance with various embodiments of the disclosure;

FIG. 12 is a conceptual illustration of a chat interface receiving a user input question for a large language model, obtaining context for the user input question from a web browser, and obtaining a prompt response for the large language model in accordance with various embodiments of the disclosure;

FIG. 13 is a logical representation of an artificial intelligence (AI) assistant module in accordance with various embodiments of the disclosure;

FIG. 14 is a flowchart illustrating example operations for performing a context acquisition process for a large language model prompt according to an implementation;

FIG. 15 is a flowchart illustrating example detailed operations for performing a context acquisition process for a large language model prompt according to an implementation;

FIG. 16 is a diagram illustrating a context acquisition logic according to an implementation;

FIG. 17 is a diagram illustrating an example of extracting contextual metadata from a URL according to an implementation;

FIG. 18 is a diagram illustrating an example of contextual information based on the metadata obtained from the example in FIG. 17 according to an implementation;

FIG. 19 is a block diagram illustrating an example computing environment that includes a data intake and query system according to an implementation;

FIG. 20 is a block diagram illustrating in greater detail an example of an indexing system of a data intake and query system, such as the data intake and query system of FIG. 19 according to an implementation;

FIG. 21 is a block diagram illustrating in greater detail an example of the search system of a data intake and query system, such as the data intake and query system of FIG. 19 according to an implementation; and

FIG. 22 illustrates an example of a self-managed network 2200 that includes a data intake and query system according to an implementation.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to various issues described herein, devices and methods discussed herein provide for an SRv6-enabled AI scheduler that can offer an open-standard, vendor-neutral solution optimizing load distribution across network links, significantly enhancing cluster performance. These embodiments can include various uses within the AI field and can be utilized by various industries. Often, these methods, devices, and/or systems can incorporate one or more large language models (LLMs).

As those skilled in the art will recognize, Artificial Intelligence (AI) is a broad field within computer science focused on creating systems that can simulate aspects of human intelligence. These systems can range from simple rule-based programs to sophisticated models capable of learning, adapting, and making decisions based on data. AI spans various branches, including robotics, computer vision, natural language processing, and reinforcement learning, each aiming to enable machines to perform tasks that traditionally require human cognition. The potential of AI lies in its ability to enhance decision-making, improve efficiency, and even drive innovation across industries. With rapid advancements in computational power and algorithm design, AI is becoming increasingly embedded in our daily lives, powering applications from personal assistants to autonomous vehicles and even aiding in scientific research and complex problem-solving.

Machine learning (ML) is a crucial subset of AI that involves systems learning from data to make predictions or decisions without being explicitly programmed for each task. Unlike traditional software, which relies on hard-coded rules, machine learning systems use algorithms that identify patterns and adjust their behavior based on experience. ML includes various techniques, such as supervised learning, unsupervised learning, and reinforcement learning, each suited to different kinds of tasks. For example, supervised learning is commonly used in classification tasks, while reinforcement learning drives decision-making in dynamic environments. ML serves as the foundation for many modern AI applications, as it enables systems to generalize from data and improve over time. As such, ML systems are central to the development of more advanced AI models and applications, including those that require nuanced understanding, like image recognition and language processing.

Large Language Models (LLMs) represent a specific application of machine learning within AI, focused on understanding and generating human language. Positioned within the broader field of natural language processing (NLP), LLMs utilize advanced machine learning architectures, particularly deep learning and transformer models, to process vast amounts of text data. Through this training, LLMs develop the ability to capture context, generate coherent responses, and perform complex language-based tasks, making them valuable tools in a range of applications, from chatbots to content creation and data analysis.

By processing vast amounts of text data, these LLMs can capture intricate patterns, nuances, and contextual relationships within language, allowing them to respond with relevance and a degree of fluency previously seen only in human communication. Broadly, LLMs work by breaking down text into tokens, converting them into vector representations, and using complex architectures with attention layers and multi-layer perceptrons to generate contextually appropriate responses. This process can enable the models to understand context, recall relevant information, and even produce creative or technical outputs based on learned knowledge. Their impact spans multiple industries. For example, they can support customer service, automate repetitive tasks, assist with brainstorming and writing, and even provide foundational support in software development and data analysis.

As those skilled in the art will recognize, the principles underlying LLMs can be generalized to other forms of AI models that handle diverse types of data, such as audio, visual, and even multimodal information. While LLMs are specialized for processing and generating language, similar architectures and concepts apply to Large Audio Models (LAMs), Large Vision Models (LVMs), and Large Foundation Models (LFMs) that incorporate multiple data types. These models operate on the same foundational ideas such as breaking down complex input (whether sounds, images, or mixed formats) into smaller, structured units, transforming these into numerical representations, and using layers of processing to capture relationships, context, and patterns within the data. Just as LLMs use tokens and embeddings for text, LAMs may segment and analyze audio signals, while LVMs and LFMs might extract features from images or combine textual and visual data for a richer, holistic understanding. This generalizable framework can enable AI to address tasks across different domains, making it possible to train models that understand, generate, and respond to varied data formats, whether in speech recognition, image analysis, or other complex, cross-functional applications. Consequently, the discussion of LLMs opens doors to understanding a broader landscape of AI technologies that share structural similarities yet target distinct types of information.

In many embodiments, the first stage in processing with an LLM can involve breaking down text into tokens, which are individual units that may represent words, subwords, or characters. This process, called tokenization, can assign each unique token a specific identifier, providing a standard format that the model can use to handle text more systematically. By transforming language input into a structured sequence of tokens, the model can gain a foundation that supports further transformations and simplifies working with complex text.

In more embodiments, the model may use an embedding matrix to convert each token into a dense vector, capturing its semantic meaning in numerical terms. The embedding matrix may hold a unique vector representation for each token, designed so that similar words or concepts can be positioned near each other in the model's multi-dimensional space. This approach can help the model achieve a form of conceptual understanding, where tokens with related meanings may be encoded in ways that reflect their relationships. By producing these vector representations, the model can start to develop a nuanced understanding of each token's role within a broader context.

With tokens now represented as vectors, the model can organize these vectors into an array that may hold the sequence of tokens from the original input text. This array can preserve the order of tokens, structuring them as a unified dataset for further processing. By arranging token information in this structured format, the model can prepare the data for a sequence of processing layers that may work to extract patterns and relationships within the data. Each vector within the array can carry information about a token's meaning and context, positioning the data for deeper levels of processing.

In further embodiments, an LLM can include one or more attention layers, which can enable the model to compare different parts of the input sequence and assess their contextual relevance. These attention layers may allow the model to assign varying levels of focus across tokens depending on the patterns it detects, highlighting words or phrases that can carry the most significance in a given context. By adjusting its focus across the sequence, the model can capture relationships between tokens that may not be apparent from isolated words. The attention mechanism can help the model build a detailed understanding, determining which parts of the input should influence the output most strongly.

Once these attention layers have established relationships within the input, the data may pass through one or more Multi-Layer Perceptrons (MLPs). In further embodiments, MLPs are fully connected neural networks that can refine the data further by identifying additional complex relationships and patterns. This stage may allow the model to distill its understanding of the input text, building on insights from the attention layers to develop an even more structured form of comprehension. The MLPs can support the model's ability to respond with greater relevance and coherence by transforming these contextual insights into a format ready for output.

Finally, in various embodiments, the refined data may reach an unembedding layer, where the model can translate its internal vector representations back into tokens. At this stage, the model can select the most probable next token based on the processed data, starting to generate a coherent output sequence. This transformation can allow the model to return from its internal numerical understanding to human-readable language, producing tokens that form a meaningful response. By iterating through these steps, the model can generate an output sequence that aligns with the context of the input, completing the journey from initial text input to comprehensible, contextually relevant output.

In specific embodiments described herein related to large-scale AI training clusters, data parallelism is a commonly adopted approach that allows multiple GPUs to operate in parallel on the same task across extensive datasets. This setup requires frequent synchronization of memory between GPUs, especially as training jobs may involve more than 15,000 iterations. After each iteration, GPUs must often communicate and exchange data, resulting in periodic, bursty flows.

Related to this are Queue Pairs (QPs) that are related to systems that rely on Remote Direct Memory Access (RDMA) for efficient data transfer. A QP can consist of two primary components, including a send queue and a receive queue. Together, these queues manage the flow of data between different nodes in a network, allowing one side to send data while the other receives it. In certain networking technologies, QPs enable direct memory access from one computer to another without involving the host CPU, greatly reducing latency and increasing data transfer speed. This is especially useful in distributed computing environments, where tasks like training machine learning models require the rapid exchange of large volumes of data across multiple machines.

Related to this, Network Interface Cards (NICs) include the hardware responsible for handling data transmission between nodes utilizing QPs. This can allow for greater parallelism and load balancing across network connections. This ability to handle numerous QPs simultaneously enables NICs to manage data flow effectively, distributing network traffic across multiple channels to optimize bandwidth and reduce bottlenecks. In distributed machine learning and AI applications, where large-scale models like LLMs may benefit from consistent, high-speed data exchange between processing units, NICs with QP capacity are desired. However, NICs have a finite capacity for QP flows, meaning they can only manage a limited number of simultaneous data streams, which restricts the number of connections or data transfers it can efficiently handle at once.

Currently, load-balancing mechanisms struggle with the large flows required by LLMs. Hash-based load balancing is particularly prone to issues like hash polarization, where specific flows are repeatedly directed through the same network paths, leading to congestion. This congestion results in significant delays in job completion times, impacting overall training efficiency and scaling. Addressing this challenge of hash polarization is essential to optimize network flow distribution and ensure that training clusters can operate at peak efficiency, minimizing delays and enabling faster AI model training. hash polarization is also problematic.

Additionally, the limited QP (i.e., flows) capacity of NICs presents a further constraint. For example, the NIC performance degrades when using more than a hundred QPs. This prevents breaking down these large flows into smaller, more manageable flows. As a result, the flow characteristics cannot be adjusted to reduce their impact on the network, necessitating a different approach to minimize congestion and polarization. Overcoming this constraint is desired for improving network efficiency in AI training environments and reducing job completion times. Finally, AI training clusters can often suffer from congestion and delays due to hash polarization in load balancing. Current solutions, including Differentiated Services Field (DSF) or User Datagram Protocol (UDP) port manipulation, have limitations in interoperability, adaptability to topology changes, and scalability.

To address these challenges, embodiments described herein teach an SRv6-enabled AI scheduler which can offer an open-standard, vendor-neutral solution that optimizes load distribution across network links, significantly enhancing cluster performance. In many embodiments, dynamic load balancing using Micro-Segment Identifier (uSID) lists are utilized by mapping the Queue Pairs (QPs) of the same source-destination pair (SRC, DST) to multiple disjoint uSID lists. This approach can ensure an even distribution of load across all links in the fabric, effectively mitigating polarization and congestion. Built on the open-standard Segment Routing over IPv6 (SRv6) framework, it can be fully interoperable with diverse vendor ecosystems, ensuring seamless compatibility.

In some embodiments, each uSID list is continuously monitored for health using Intelligent Path Monitoring (IPM), enabling rapid detection and response to path failures for enhanced resilience. Additionally, the solution offers deployment flexibility, as it can be implemented on either Network Interface Cards (NICs) or Top-of-Rack (ToR) switches, accommodating various infrastructure configurations.

In additional embodiments to address the polarization and congestion challenges in AI training clusters, a deterministic Source Routed AI Fabric can be utilized. For example, it is envisioned that various implementations may utilize SRv6 to steer traffic between GPUs, offering a scalable and open-standards-based method that enhances load distribution across network fabric links. Upon job orchestration, each source and destination (SRC, DST) may be mapped to multiple (K) disjointed uSID lists. These uSID lists may be precomputed with the specific objective of balancing traffic load across the network fabric by factoring in link utilization, using a weighted assignment that optimizes link usage and prevents congestion. It should be appreciated that the mechanism may be executed at the DPU (NIC) or at the TOR, depending on where we want to push the “intelligence”.

It is envisioned that the Scheduler, upon job orchestration, for each (SRC, DST) GPU pair it computes multiple disjoint uSID lists that are installed in both homing ToRs of the NIC associated with that GPU. The TOR receives an RDMA over Converged Ethernet v2 (ROCEv2) packet of the form: Eth, IP (SRC, DST), UDP, BTH (QP_identifier). The TOR steers all traffic for that (SRC, DST) into the set of uSID lists that were computed by the controller. The specific SID list to be used can be picked according to ECMP hashing using as input parameters (IP_SRC, IP_DST, UDP_Ports, QP_id). The routers along the DC fabric can steer according to the specific SID list. If, either through the congestion mechanisms (ECN, DCQCN) or through the IPM measurements, it is detected that that specific path is not performing well, then the uSID list can be disabled and the traffic is repathed or otherwise rerouted to another disjoint uSID list. It should be appreciated that the change from the old uSID list to the new uSID list may be flowlet-based (i.e., waiting for a specific amount of time without traffic within the flow to avoid any mis-ordering).

In many embodiments, the Scheduler computes multiple disjoint uSID lists for each source-destination pair (SRC, DST) during job orchestration. On the Network Interface Card (NIC), each Queue Pair (QP) can be assigned two uSID lists: a primary list and a backup list. The NIC crafts the ROCEv2 packet and adds an additional IPv6 header containing the uSID list associated with that QP. As the packet traverses the data center fabric, the routers steer it based on the specific SID list. If performance issues are detected through congestion mechanisms such as ECN or DCQN, or through Intelligent Path Monitoring (IPM) measurements, the system disables the affected uSID list and seamlessly switches to the backup list. The controller may subsequently install a new uSID list on the NIC to ensure optimal performance for future transmissions.

In additional embodiments, traffic associated with each QP may be evenly distributed across multiple, dynamically selected paths in the network fabric, effectively removing polarization without requiring proprietary solutions. By leveraging SRv6's capabilities, embodiments of the disclosure provide a resilient, standardized method for managing high throughput, synchronized GPU communication in AI clusters, thereby improving overall job completion times and network efficiency. Those skilled in the art will appreciate the open standard and interoperability of the embodiments described herein. Furthermore, the various mechanisms may be implemented on the NIC, or on the Top-of-Rack, thereby by adding flexibility to one or more deployment options. To that end, SID lists may be combined with IPM for health monitoring. Consequently, path disruption may be adjusted while maintaining optimal load distribution.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

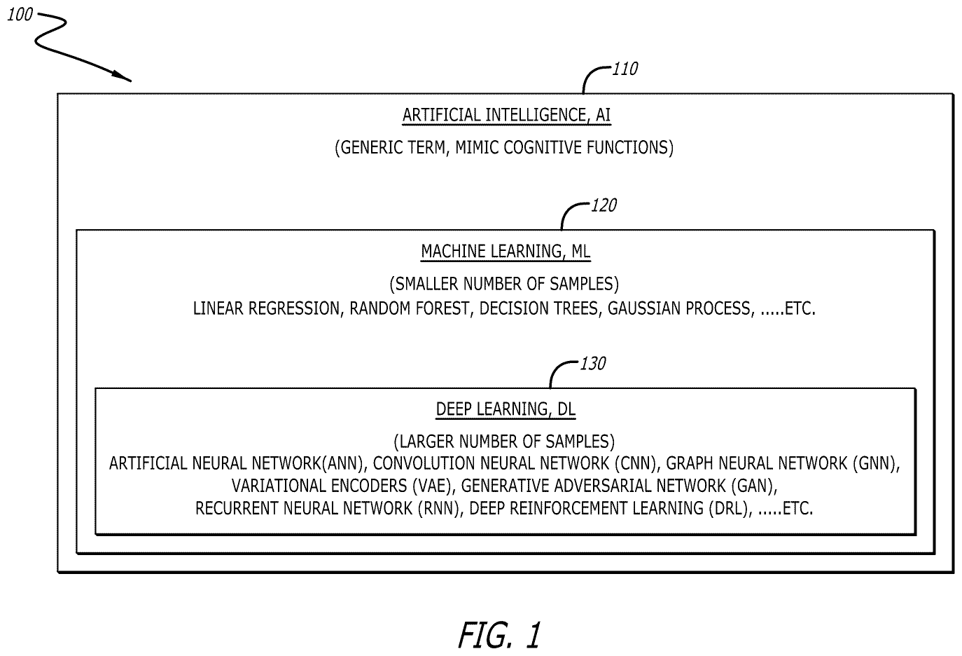

Referring to FIG. 1, a diagram 100 depicting various subsets of artificial intelligence in accordance with various embodiments of the disclosure is shown. Artificial intelligence (AI) 110 is typically understood in the art to be the development of machines and algorithms that mimic human intelligence, for example, by optimizing actions to achieve certain goals. At its core, AI 110 often involves designing algorithms and models that mimic cognitive functions, such as learning, reasoning, problem-solving, perception, and even language understanding. Unlike traditional computer programs that follow a fixed set of instructions, AI systems have the ability to adapt, improve, and make decisions based on input data and environmental interactions.

AI 110 can be considered a generic term because it encompasses a wide range of subfields and techniques, from simple rule-based systems to advanced machine learning and deep learning models. These AI techniques are used to simulate various aspects of human cognition. For example, machine learning (ML) 120 allows computers to learn from data patterns without explicit programming for each task, while natural language processing (NLP) enables machines to understand and generate human language. Deep learning (DL) 130, a more advanced branch of AI, uses neural networks to automatically learn complex patterns from large datasets, akin to the human brain's information processing. This versatility makes AI a powerful tool across diverse applications, including image recognition, autonomous driving, voice assistants, healthcare diagnostics, and materials discovery.

A goal of AI is often to create systems that can function autonomously and intelligently in real-world scenarios. As AI 110 continues to evolve, it can increasingly mirror human-like cognition, enabling machines to not just process data but to “think” in a way that can handle uncertainty, make predictions, and even interact with their surroundings in a meaningful manner. While AI systems are far from achieving the full breadth of human intelligence, their ability to replicate specific cognitive functions makes them invaluable in tackling complex, data-driven challenges.

Machine Learning (ML) 120 is a subset of Artificial Intelligence (AI) 110 that focuses on the development of algorithms and statistical models that enable computers to learn and make decisions from data without explicit programming. In traditional programming, a computer is given a fixed set of rules to follow, but ML 120 can shift this paradigm by allowing systems to identify patterns, adapt, and improve their performance based on the data they encounter. This data-driven approach makes ML particularly valuable for tasks that are too complex or dynamic to define using straightforward rules, such as, for example, recognizing images, predicting consumer behavior, or diagnosing diseases.

ML models can be configured to analyze large amounts of data to identify trends and relationships that inform their predictions or classifications. The process typically involves three stages: training, validation, and testing. During training, the model learns from a dataset by adjusting its internal parameters to minimize errors between its predictions and the actual results. Techniques like linear regression, decision trees, random forests, and Gaussian processes are commonly used in ML 120. These algorithms can handle various data types, including numerical, categorical, and structured datasets like spreadsheets or grids. One of the key strengths of ML is its ability to generalize from the training data to make accurate predictions on new, unseen data.

However, traditional ML methods rely heavily on feature engineering, wherein human experts manually identify the most relevant features or patterns within the data. For example, when using ML 120 for image recognition, an expert might need to extract features like edges, textures, or color patterns before feeding them into a model. This requirement can limit the scalability of traditional ML approaches, especially when dealing with large, unstructured datasets such as images, text, or graphs. Additionally, ML algorithms may often work best when provided with relatively structured data, and they often need a reasonable amount of samples (typically more than 100) to learn effectively.

Deep Learning (DL) 130 is a specialized subset of Machine Learning (ML) 120 that employs multi-layered artificial neural networks to automatically learn complex patterns and representations from large, often unstructured datasets. Inspired by the way the human brain processes information, DL 130 consists of interconnected layers of “neurons” that can adaptively change as they are exposed to more data. Unlike traditional ML methods, which require manual feature engineering to identify key data characteristics, DL models can automatically extract features directly from raw data, such as images, text, or molecular structures. This automated feature extraction allows DL 130 to handle data types and tasks that were previously difficult or impossible for ML models to tackle effectively.

DL models, including Convolutional Neural Networks (CNNs), Graph Neural Networks (GNNs), and Recurrent Neural Networks (RNNs), excel at processing various forms of data. CNNs are particularly effective for image analysis, recognizing intricate patterns in visual inputs, making them indispensable in areas like materials science for analyzing microscopic images or detecting defects in materials. GNNs, on the other hand, are designed to work with graph-based data, such as molecular structures, social networks, or atomic interactions. They can learn the dependencies and relationships within graph-like structures, which is crucial for predicting properties of complex molecules and materials. RNNs and their variants, such as Long Short-Term Memory (LSTM) networks, are suited for sequential data like time series or natural language processing, allowing for the analysis and generation of textual information or the prediction of temporal patterns in scientific research.

One of the defining characteristics of deep learning is its requirement for large datasets (typically over 500 samples for example) to effectively train neural networks. The deep, multi-layered structure of these networks enables them to capture highly complex and abstract representations of the data, but it also demands significant computational power. Techniques like Variational Autoencoders (VAEs) and Generative Adversarial Networks (GANs) add to the versatility of DL by enabling the generation of new data samples that resemble the training set, aiding in areas such as materials discovery and synthetic data creation. Deep Reinforcement Learning (DRL) combines neural networks with decision-making processes to solve problems that involve optimization and control, further expanding DL's application potential. In summary, DL's ability to automatically learn from raw, unstructured data and model intricate patterns makes it a powerful tool in AI, particularly for complex domains like image recognition, natural language processing, and materials science.

Artificial Neural networks (ANNs or sometimes just NNs) are often a foundation of a DL system. The basic unit of a neural network is typically the perceptron, which can take inputs, assigns weights to these inputs, and combines them to produce an output. The final output is then passed through an activation function (such as, for example, ReLU, sigmoid, or hyperbolic tangent) to introduce non-linearity, which enables the network to model complex patterns.

Neural networks are typically trained through a process of backpropagation, where the system's predictions are compared against the known output, and a loss function is used to measure the difference between the prediction and the actual result. The network's weights can be adjusted through a process called gradient descent, which can be configured to minimize the loss function over time. However, the training process can be prone to problems like overfitting (where the model performs well on the training data but poorly on new data). To counter this, techniques such as regularization (e.g., regularization, dropout), early stopping, and mini batches can be utilized to prevent the network from becoming overly specialized to the training set.

CNNs are a specific type of ML 130 neural network designed to work particularly well with image data, making them highly relevant for image and video data processing. As those skilled in the art will recognize, CNNs typically use specialized layers known as convolutional layers, which apply filters (also known as kernels) to the input data. These filters slide over the input (e.g., an image), detecting patterns like edges or textures, which are then passed to the next layer for further processing. The advantage of CNNs is their ability to automatically learn and extract relevant features from raw data without the need for manual feature engineering. Furthermore, pooling layers (e.g., max-pooling or average pooling) are often added after convolutional layers to reduce the dimensionality of the data, helping to make the system more efficient while retaining the most important information. After several layers of convolutions and pooling, the CNN can output a prediction that is relevant to the underlying process being executed.

While CNNs are well-suited for grid-based data like images, many real-world problems in can involve non-grid data. This type of data may better be represented as a graph, where nodes represent entities (e.g., specific items) and edges represent relationships between them (e.g., characteristics, values, etc.). Thus, Graph Neural Networks (GNNs) can be utilized to operate on such graph-based data.

In GNNs, information is passed between nodes through edges in a process called message passing. This allows the network to capture dependencies and relationships within the graph structure. The key feature of GNNs is their ability to aggregate information from neighboring nodes, which is crucial in predicting properties that depend on the current/local structure, such as the behavior of an entity or the properties of a related to that or associated entities.

Generative models aim to learn the underlying distribution of a dataset and generate new samples that resemble the original data. Two common types of generative models are Variational Autoencoders (VAEs) and Generative Adversarial Networks (GANs). VAEs are often configured to work by encoding data into a lower-dimensional latent space and then decoding it back into its original form. This can allow for the generation of new data by sampling points from the latent space. Similarly, GANs often consist of two components: a generator that creates fake/generated data and a discriminator that tries to distinguish between real and fake data. The two components can be trained in a competitive process where the generator tries to “fool” the discriminator, leading to increasingly realistic generated data.

Reinforcement Learning (RL) involves an agent learning to make decisions by interacting with an environment and receiving feedback (rewards or penalties) based on its actions. Deep Reinforcement Learning (DRL) combines RL with DL techniques, allowing agents to learn from high-dimensional inputs, such as images or complex data simulations. In various embodiments, DRL can be used in scenarios where an optimal decision needs to be made. The combination of RL and DL can allow for learning from raw data, making it a powerful tool for dynamic and real-time decision-making within various embodiments.

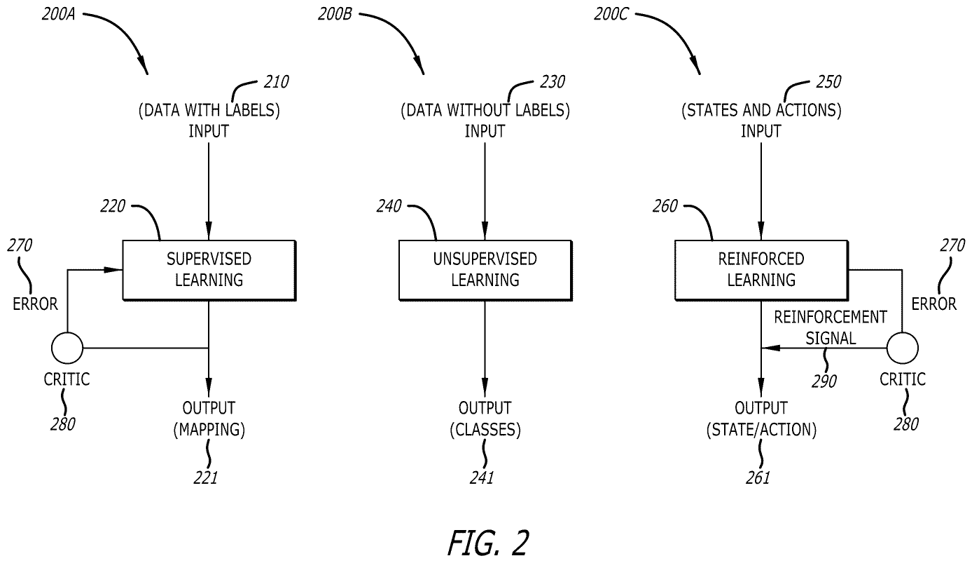

Although a specific embodiment for a diagram 100 depicting various subsets of artificial intelligence suitable for carrying out the various steps, processes, methods, and operations described herein is discussed with respect to FIG. 1, any of a variety of systems and/or processes may be utilized in accordance with embodiments of the disclosure. For example, other subset may be present and available for use within AI 110. Those skilled in the art will recognize that the diagram 100 presented in FIG. 1 is simplified for illustration purposes and various methods and techniques may interact with other areas (ML 120 with DL 130, etc.). The elements depicted in FIG. 1 may also be interchangeable with other elements of FIGS. 2-10 as required to realize a particularly desired embodiment.

Referring to FIG. 2, different methods of machine-based learning in accordance with various embodiments of the disclosure are shown. In many embodiments, a machine learning model is defined as a mathematical representation of the output of the training process. A machine learning model is often considered similar to computer software designed to recognize patterns or behaviors based on previous experience or data. However, the learning algorithm can discover patterns within the training data, and output an ML model which can capture these patterns and make predictions on new data.

ML models can be understood as a device that has been trained to find patterns within new data and make predictions. These models can be represented as a complex mathematical function that would be impractical for a human to calculate that takes requests in the form of input data, makes predictions on input data, and then provides an output in response. First, these models can be trained over a set of data, and then they are provided an algorithm or other task to reason over data, extract the pattern from feed data and learn from that data. Once the model(s) is/are trained, they can be used to predict a new and previously unseen dataset.

There are various types of machine learning models available based on different business goals and data sets available. Often, based on the desired application, ML models can be configured as or settle into one of three different model types: supervised learning, unsupervised learning, and/or reinforcement learning. Supervised learning can further be broken down into two categories of classification and regression. Likewise, unsupervised learning can be divided into three categories: clustering, association rule, and/or dimensionality reduction.

In the embodiment depicted in FIG. 2, a supervised learning system 200A is shown. The supervised learning system 200A can be configured with a supervised learning model 220 that accepts input data 210 and generates an output 221. However, the output data is often reviewed by a critic 280 that can determine one or more errors 270 that are fed back into the supervised learning model 220 for use in updating.

Supervised learning systems 200A are often considered the simplest machine learning model to understand in which input data (such as training data) has a known label or result as an output. So, the supervised learning model 220 can be understood to work on the principle of input-output pairs. As such, a function can be trained using a training data set, which is then applied to unknown data and makes some predictive performance. Supervised learning is task-based and mostly tested on labeled data sets.

Supervised learning systems 200A may often involve one or more regression problems. In regression problems, the output is a continuous variable. Some commonly used Regression models include linear regression, decision trees, and random forests. Linear regression is typically the most straight forward machine learning model in which a prediction of one output variable is made using one or more input variables. The representation of linear regression can be processed as a linear equation, which combines a set of input values (denoted as x) and a predicted output (denoted as y) for the set of those input values. As those skilled in the art will recognize, this may be represented in the form of a line: Y=bx+c. A typical aim of a linear regression-based model can be to find the optimal fit line that best fits the available data points. Linear regression can be extended to multiple linear regressions (finding a plane of best fit in higher dimensional space) and polynomial regressions (finding the best fit curve).

Decision trees are also popular machine learning models that can be used for both regression and classification problems. A decision tree uses a tree-like structure of decisions along with their possible consequences and outcomes. In this, each internal node is used to represent a test on an attribute while each branch is used to represent the outcome of the test. The more nodes a decision tree has, the more accurate the result will be. The advantage of decision trees is that they are intuitive and easy to implement, but may lack accuracy depending on the available computational or time resources available.

Random forests are an ensemble learning method, which may consist of a large number of decision trees. For example, each decision tree in a random forest predicts an outcome, and the prediction with the majority of votes is considered as the outcome. A random forest model can be used for both regression and classification problems. For the classification task, the outcome of the random forest may be taken from the majority of votes. Whereas in the regression task, the outcome can be taken from the mean or average of the predictions generated by each tree.

Classification models are another type of supervised learning, which can be used to generate conclusions from observed values in one or more categorical forms. For example, a classification model can identify if an email is spam or not; whether a certain routing pathway is optimal or not, etc. Classification algorithms can also be used to predict between two or more classes and/or categorize an output into different groups. For these classification systems, a classifier model can be designed that classifies the dataset into different categories, and each category can subsequently be assigned a label. As those skilled in the art will recognize, there are currently two main types of classifications in machine learning: binary and multi-class. Binary classification can be utilized when there are only two possible classes (i.e., yes/no, dog/cat, etc.). Multi-class classification can be utilized when there are more than two possible classes, thus requiring a multi-class classifier.

One of the potential classification processes is logistic regression. Logistic regression can be used to solve various classification problems in machine learning systems. These processes are similar to linear regression but are often used to predict categorical variables. While some variations can be configured to generate a prediction as an output in either “yes” or “no”, 0 or 1, “true” or “false”, etc. However, in some embodiments, the system can instead be configured to not give exact values, but instead provide probabilistic values between zero and one, etc.

Another classification process that can be utilized is a support vector machine (SVM) which is widely used for classification and regression tasks. However, the main aim of SVM is to find the best decision boundaries in an N-dimensional space, which can be utilized to segregate data points into classes, and generate a best decision boundary often known as a hyperplane. SVM processes can select the extreme vector to find a hyperplane, wherein these vectors are known as support vectors.

Naïve Bayes is another popular classification algorithm used in machine learning. This process receives its name as it is based on Bayes theorem and follows the naïve (independent) assumption between the features which is often given as the formula:

$$P ( y \vert X ) = \frac{P ( X \vert y ) * P ( y )}{P ( X )}$$

This formula takes a class or target y and a predictor attribute (X) and calculates a posterior probability P(y|X) of that class given a particular predictor. P(y) is the prior probability of that class, P(X) is the prior probability of the predictor, and P(X|y) is the likelihood or probability of the predictor given the class. As those skilled in the art will recognize, this may be more succinctly understood as the posterior chance being a result of the prior results times the likelihood divided by the evidence available. Each naïve Bayes classifier assumes that the value of a specific variable is independent of any other variable/feature. For example, if a fruit needs to be classified based on color, shape, and taste. So yellow, oval, and sweet will be recognized as mango. Here each feature is independent of other features.

Again, in the embodiment depicted in FIG. 2, an unsupervised learning system 200B is shown. The unsupervised learning system 200B can be configured with an unsupervised learning model 240 that accepts input data 230 and generates an output 241. Unlike other model types, there are no critics or error signals to process. Unsupervised learning models 240 can implement the learning process opposite to supervised learning, which means it enables the model to learn from an unlabeled training dataset. Based on the unlabeled dataset, the unsupervised learning model 240 can predict the output. Using an unsupervised learning system 200B, the unsupervised learning model 240 can learn hidden patterns from the dataset by itself without any supervision. In various embodiments, unsupervised learning models 240 are often utilized to perform tasks involving clustering, association rule learning, and/or dimensional reduction.

Clustering is an unsupervised learning technique that involves clustering or grouping the available data points into different clusters based on similarities and/or differences. The objects or data points with the most similarities remain in the same group, and they have no or very few similarities from other groups. Clustering algorithms can be used in a variety of different tasks such as, but not limited to image segmentation, statistical data analysis, market segmentation, and the like. Some commonly used clustering algorithms that can be selected include K-means Clustering, hierarchal Clustering, DBSCAN, etc.

Association rule learning is an unsupervised learning technique which finds unique relations among variables within a large data set. In many embodiments, a primary aim of this type of learning algorithm is to find the dependency of one data item on another data item and map those variables accordingly so that it can satisfy some desired outcome. This algorithm can be applied in market basket analysis, web usage mining, continuous production, etc. However, those skilled in the art will recognize that other scenarios may be available based on the desired application. Some popular algorithms of association rule learning are Apriori Algorithm, Eclat, and FP-growth algorithm.

In additional embodiments, the number of features/variables present in a dataset can be understood as the dimensionality of the dataset, and the technique used to reduce the dimensionality is known as a dimensionality reduction technique. Although more data provides more accurate results, it can also affect the performance of the model/algorithm, such as yielding overfitting outcomes, etc. In such cases, dimensionality reduction techniques can be utilized. It is often desired that this process involves converting the higher dimensions dataset into lesser dimensions dataset while also ensuring that the ensuing results provide similar information. Different dimensionality reduction methods can be utilized, such as, but not limited to, PCA (Principal Component Analysis), Singular Value Decomposition (SVD), etc.

Finally, in the embodiment depicted in FIG. 2, a reinforcement learning system 200C is shown. The reinforcement learning system 200C can be configured with a reinforcement learning model 260 that accepts input data 250 and generates an output 261. In reinforcement learning, the reinforcement learning model 260 learns actions for a given set of states that lead to a goal state. In the embodiment depicted in FIG. 2, a critic 280 can receive or otherwise notice an error 270 within the reinforcement learning model 260 actions, and adjust the outcome/output such that the “reward” or “punishment” is adjusted to better model the future behaviors or processing of the reinforcement learning model 260.

It is a feedback-based learning model that can takes feedback signals after each state or action by interacting with the environment. This feedback works as a reward (positive for each good action and negative for each bad action), and the agent's goal is to maximize the positive rewards to improve their performance. The behavior of the model in reinforcement learning is similar to human learning, as humans learn things by experiences as feedback and interact with the environment. Popular methods of reinforcement learning including q-learning, state-action-reward-state-action (SARSA), and deep Q network.

Q-learning is one of the popular model-free algorithms of reinforcement learning, which is based on the Bellman equation. It often aims to learn the policy that can help the AI agent to take the best action for maximizing the reward under a specific circumstance. It can incorporate Q values for each state-action pair that indicate the reward to following a given state path, and it tries to maximize that Q-value.

SARSA is an on-policy algorithm based on the Markov decision process. In many embodiments, it can use the action performed by the current policy to learn the Q-value. The SARSA algorithm stands for State Action Reward State Action, which symbolizes the tuple (s, a, r, s′, a′). Finally, deep Q neural networking (or DQN) is Q-learning within a neural network. It can be deployed within a big state space environment where defining a Q-table would be a complex task. So, in these embodiments, rather than using a Q-table, the neural network instead utilizes Q-values for each action based on the state.

Although a specific embodiment for different methods of machine-based learning suitable for carrying out the various steps, processes, methods, and operations described herein is discussed with respect to FIG. 2, any of a variety of systems and/or processes may be utilized in accordance with embodiments of the disclosure. For example, those skilled in the art will recognize that methods of learning described herein are generalized and may incorporate other types developed as well as a combination of one or more methods based on the goals of the desired application. The elements depicted in FIG. 2 may also be interchangeable with other elements of FIGS. 1 and 3-10 as required to realize a particularly desired embodiment.

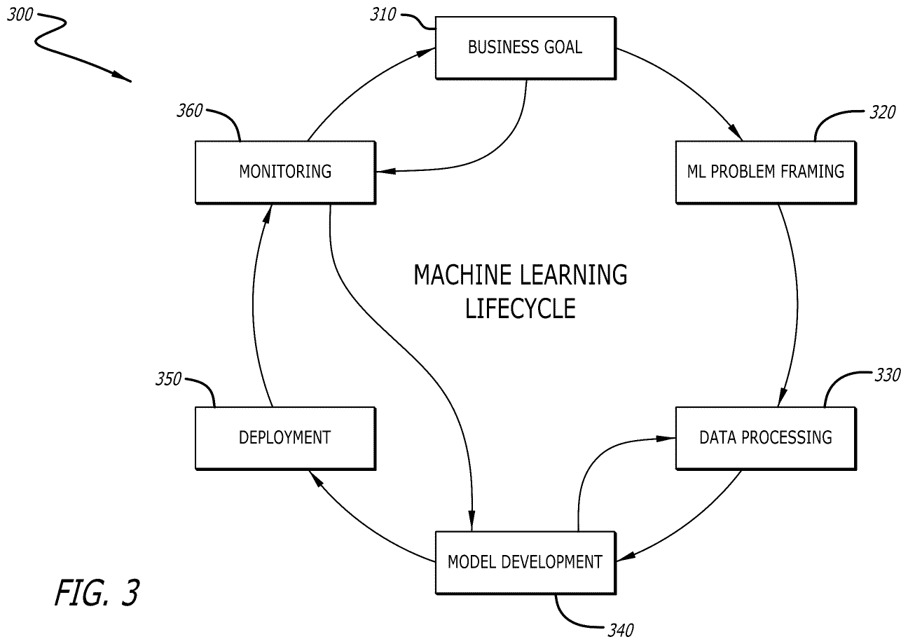

Referring to FIG. 3, a machine learning lifecycle 300 in accordance with various embodiments of the disclosure is shown. During the development of machine learning systems, the embodiment depicted in FIG. 3 can provide a framework for how to structure the design and maintenance of these systems. This machine learning lifecycle 300 outlines various stages involved in building, deploying, and improving ML models to solve real-world problems. By following this structured process, businesses and organizations can ensure that their machine learning projects align with strategic goals, use data effectively, and adapt to changing conditions over time. This machine learning lifecycle 300 emphasizes that developing a machine learning model is not a one-time effort but an iterative process requiring ongoing monitoring and adjustment. The feedback loop inherent in the machine learning lifecycle 300 allows for continual refinement and optimization of models to maintain their accuracy and relevance.

In many embodiments, a first stage of the machine learning lifecycle 300 is identifying the business goal 310, which sets the overall direction and purpose of the ML project. This can involve understanding the specific problems or opportunities within the business or project that machine learning can address. A clear business goal 310 ensures that the project remains focused on delivering tangible value. Without a well-defined goal, it can be challenging to align the subsequent stages of the ML lifecycle 300, as the choice of model, data processing methods, and performance metrics can all depend on what the business aims to achieve.

Establishing a proper business goal 310 can also involve engaging with key stakeholders and developers to gather requirements and set success criteria. It can provide a roadmap that outlines what success looks like and helps in framing the ML problem. Clearly defined goals not only help guide the project but also provide benchmarks for evaluating the effectiveness of the deployed model once it enters production.

Once the business goal 310 is established, various embodiments take a next step involving ML problem framing 320, wherein the goal is translated into a specific machine learning task. This can involve selecting the appropriate type of ML problem, such as classification, regression, clustering, or recommendation, and defining the target variables or outputs. Proper problem framing can be important as it determines the particular data requirements, choice of model, and evaluation metrics.

During this stage, it is also prudent to consider the constraints and assumptions that may affect the model's development. This might include data availability, computational resources, ethical considerations, or regulatory compliance. Properly framing the problem ensures that the model development aligns with the business's needs and that the problem is broken down into manageable steps, ultimately increasing the project's chances of success.

Data processing 330 is a step in many embodiments where raw data is collected, cleaned, and transformed into a format suitable for machine learning. This step can involve gathering data from various sources, removing errors or inconsistencies, handling missing values, and normalizing or scaling features to ensure that the model can learn effectively. Feature engineering is often a part of this stage, where new features are derived from the raw data to capture more relevant information and improve model performance.

The quality and preparation of the utilized data can significantly impact the model's accuracy and reliability. Inadequate or poorly processed data can lead to biased or inaccurate predictions, no matter how advanced the model is. Hence, data processing 330 can require or at least benefit from careful planning and iterative refinement. Once the data is processed, it is typically split into training, validation, and test sets to develop and evaluate the model, ensuring that it generalizes well to new, unseen data.

Model development 340 is a phase in a number of embodiments where machine learning algorithms are selected, trained, and refined to create a model that addresses the framed problem. This stage can involve choosing the appropriate algorithm (e.g., decision trees, neural networks, support vector machines), setting up the model's architecture, and defining hyperparameters that will guide the training process. The model is trained on the processed data to identify patterns and relationships that allow it to make predictions or decisions.

During model development 340, the model can be evaluated using the validation dataset to fine-tune its parameters and improve performance. Techniques like cross-validation, regularization, and hyperparameter tuning can be used to prevent overfitting and ensure the model generalizes well. If proper steps are taken, the result is a model that, once it meets predefined performance metrics, is ready for deployment in a real-world environment. However, this process often involves several iterations to optimize the model for the specific business goal, indicated by the arrow back to data processing 330.

In further embodiments, deployment 350 is the stage where the developed model is integrated into the production environment to perform its intended tasks. This phase may involve setting up the necessary infrastructure, such as APIs or cloud-based services, to allow the model(s) to process live data and generate predictions. Deployment 350 can transform the model from a research tool into a functional component of a business process or product, providing real-time insights, automations, or decisions.

Proper deployment 350 can also include setting up mechanisms for logging, error handling, and user access. Since real-world environments are often dynamic and differ from training conditions, deployment may require continuous adaptation and updates to ensure the model(s) operates efficiently. This step can be important because a model's success is not only determined by its performance metrics but also by its ability to provide actionable results that align with the business goal 310.

In more embodiments, monitoring 360 is the ongoing process of tracking the model's performance and behavior after deployment. It involves collecting data on the model's predictions, accuracy, latency, and error rates to detect issues such as concept drift, where changes in the underlying data patterns can degrade the model's accuracy. By continuously monitoring 360, teams can identify when the model's performance drops and requires retraining or adjustments to align with the evolving data.

Monitoring 360 can also encompass aspects like user feedback, security, and compliance, ensuring that the model remains effective, reliable, and ethical in its application. It may serve as the feedback loop in the lifecycle, where insights gained from monitoring feed back into the earlier stages, particularly data processing 330 and model development 340, to refine the model(s) as needed. This iterative process allows the machine learning system to adapt and maintain its alignment with the original business goal 310 over time.

Although a specific embodiment for a machine learning lifecycle 300 suitable for carrying out the various steps, processes, methods, and operations described herein is discussed with respect to FIG. 3, any of a variety of systems and/or processes may be utilized in accordance with embodiments of the disclosure. For example, the particular route of development of the model(s) may not follow this cycle completely. As those skilled in the art will recognize, there are a variety of ways to develop AI products that include various iterative steps that aide in development and refinement of different model(s). The elements depicted in FIG. 3 may also be interchangeable with other elements of FIGS. 1-2 and 4-10 as required to realize a particularly desired embodiment.

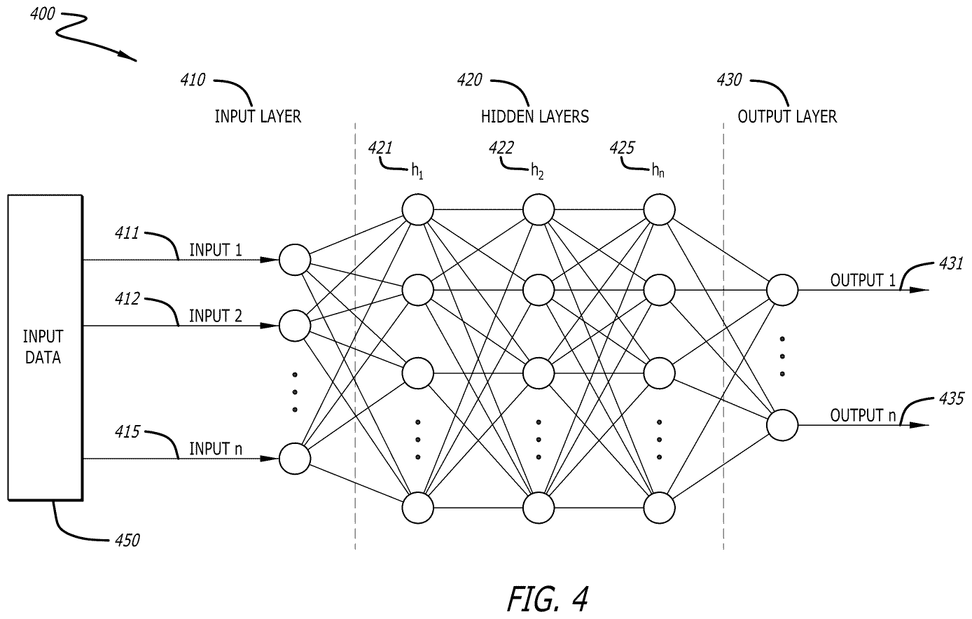

Referring to FIG. 4, an exemplary neural network 400 in accordance with various embodiments of the disclosure is shown. The embodiment depicted specifically depicts a feedforward neural network with multiple layers. This type of network consists of an input layer 410, one or more hidden layers 420, and an output layer 430. Each layer contains nodes (or neurons) that are interconnected, representing how data flows through the network. The input layer 410 can receive raw data, which is then processed by the hidden layers 420 through weighted connections and activation functions. These hidden layers 420 can enable the network to learn complex patterns and relationships within the data.

The final output layer 430 produces the network's predictions or classifications based on the processed input. The interconnected nature of the nodes allows the neural network 400 to learn from data during training by adjusting the weights of connections to minimize prediction errors. This structure is the foundation of deep learning models, as adding more hidden layers 420 can create a deep neural network, capable of tackling highly complex tasks such as image recognition, natural language processing, and pattern detection in large datasets.

A perceptron or a single artificial neuron is the building block of artificial neural networks (ANNs) and can perform forward propagation of information. For a set of inputs to the perceptron, weights (and biases to shift wights) can be assigned. These inputs and weights can be multiplied out correspondingly together to get a sum output. Those skilled in the art will recognize tools such as, but not limited to, PyTorch, Tensorflow, and MXNet as training packages for common neural network tasks. However, it is contemplated that other tools may be developed specifically for the neural network tasks related to the embodiments described herein.

In additional embodiments, the weight matrices of a neural network can be initialized randomly or obtained from a pre-trained model. These weight matrices can be multiplied with the input matrix (or output from a previous layer) and subjected to a nonlinear activation function to yield updated representations, which are often referred to as activations or feature maps. The loss function (also known as an objective function or empirical risk) can often be calculated by comparing the output of the neural network and the known target value data.

Feedforward networks, such as the neural network 400 depicted in the embodiment of FIG. 4, are often configured as neural networks where information moves in one direction, from the input layer through the hidden layers to the output layer, without any cycles or loops. They are primarily used for tasks such as classification, regression, and simple pattern recognition, where each input is processed independently of others. In contrast, backpropagation is not a separate type of network but rather a training algorithm commonly used in both feedforward and other types of networks, like recurrent neural networks (RNNs).

Backpropagation involves adjusting the weights of the network in the reverse direction (from output to input) based on the error between the predicted output and the actual target during training. While feedforward describes the structure and data flow within the network, backpropagation is a technique used to optimize the model. Feedforward networks are ideal for straightforward tasks where input-output relationships are not sequential or time-dependent. However, for problems involving learning complex patterns over time, such as speech recognition or time-series analysis, networks that leverage backpropagation for training, like RNNs or deep feedforward networks with many hidden layers, become necessary to capture these intricate dependencies.

Typically, in these network arrangements, the weights are iteratively updated via various methods including, but not limited to, stochastic gradient descent algorithms in order to help minimize the loss function until the desired accuracy is achieved. Most modern deep learning frameworks can facilitate this by using reverse-mode automatic differentiation to obtain the partial derivatives of the loss function with respect to each network parameter through recursive application of the chain rule. Colloquially, this is also known as back-propagation. Common gradient descent algorithms can include, but are not limited to, Stochastic Gradient Descent (SGD), Adam, Adagrad etc. The learning rate is an important parameter in gradient descent. Except for SGD, all other methods use adaptive learning parameter tuning. Depending on the objective such as classification or regression, different loss functions such as Binary Cross Entropy (BCE), Negative Log Likelihood Loss (NLLL) or Mean Squared Error (MSE) can be used.

Neural network architecture is commonly used for a wide range of tasks in fields such as computer vision, natural language processing, financial forecasting, and materials science. For instance, it can be employed to recognize patterns in images, such as identifying objects or faces, or to classify text into categories, like spam detection in emails. It is also useful in regression problems, such as predicting stock prices or energy consumption, where input features can be processed to output continuous values. However, this is a general example of an artificial intelligence (AI) model, illustrating how a feedforward neural network works. Depending on the problem, other methods and models may be more appropriate. For example, convolutional neural networks (CNNs) are often used for image processing tasks, while recurrent neural networks (RNNs) are suitable for sequential data like time series data or text. Additionally, simpler models like linear regression, decision trees, or support vector machines (SVMs) may be sufficient if the problem is less complex, or the dataset is relatively small. The embodiment depicted in FIG. 4 is presented as an exemplary ML solution that may be deployed within one or more methods or systems described herein.

In many embodiments, the input layer 410 is the first layer in a neural network 400 and serves as the initial point where raw data is introduced into the model. Each node (or neuron) in this layer represents an individual feature or variable from the dataset, allowing the network to receive and process various types of data, such as pixel values in an image, numerical features in a spreadsheet, or words in a text document. For instance, in image recognition tasks, the input layer can consist of nodes that correspond to the pixel values of the image, providing the network with the visual information needed to identify objects or patterns. The number of nodes in the input layer directly depends on the number of features present in the dataset. If there are one-hundred features in the data, the input layer will typically have one-hundred nodes, each conveying one piece of the information to the subsequent layers. In more embodiments, the inputs of the neural network 400 are generally scaled i.e., normalized to have a zero mean and/or unit standard deviation. Scaling can also be applied to the input of hidden layers (using batch or layer normalization) to improve the stability of neural network 400.

Unlike the hidden layers 420 and output layers 430, the input layer 410 typically does not perform any computations or transformations on the data. Its primary function is often to pass the input data to the next layer in the network, the first hidden layer 421. However, it is often desired that the data fed into this layer is preprocessed appropriately, such as being normalized or standardized, to ensure that the neural network can learn efficiently. Proper preprocessing, like scaling numerical values or encoding categorical variables, can help the network process data uniformly, facilitating more stable and faster convergence during training.

The input layer's design depends on the nature of the problem. For example, in natural language processing, the input layer may represent words encoded as numerical vectors, while in time-series analysis, each node might represent a data point in a sequence. While the input layer 410 itself does not modify the data, it sets the stage for the neural network to extract complex patterns and relationships through the deeper layers. This flexibility in handling various types of input make the neural network 400 a powerful tool for a diverse set of applications.

With respect to the embodiments described herein, the input layer may be configured with a plurality of inputs providing input data 450. As those skilled in the art will recognize, input data 450 can vary in form, structure, or size based on the specific application desired. For example, in large language models, the input may be one or more tokens taken from an input provided by a user. The neural network 400 may also be a more specific step or sub-step within a larger AI/ML system. In some embodiments, the neural network 400 may be a part of a multi-layer perceptron within a large language model. However, as those skilled in the art will recognize, additional setups can be configured to format the input data 450 in a satisfactory way prior to processing by the neural network 400.

In a number of embodiments, the neural network 400 may comprise a plurality of hidden layers 420. The embodiment depicted in FIG. 4 comprises a first hidden layer 421, a second hidden layer 422, and an nth hidden layer 425, which are denoted as h₁, h₂, and hₙ respectively. In many embodiments, the hidden layers 420 are where the core of the model's learning and pattern recognition occurs. In each hidden layer, individual neurons receive inputs from the previous layer, apply a set of weights, add a bias, and pass the result through an activation function (e.g., ReLU, leaky ReLU, sigmoid, hyperbolic tangent (tanh), Swish, etc.). This process can introduce non-linearity, allowing the network to capture complex patterns in the data that simple linear models cannot. The intricate web of connections among neurons across layers helps the network transform and process input features into representations that become progressively more abstract and useful for making predictions.

The first hidden layer 421 h₁ receives direct input from the input layer, transforming the raw data into an initial set of features. For example, in an image recognition task, this layer might begin identifying basic patterns, such as edges or simple textures. The output of the first hidden layer 421 is then passed to a second hidden layer 422 h₂, which builds upon the features identified by the first hidden layer 421. This deeper layer might start recognizing more complex patterns, such as shapes or specific object components, by combining the lower-level features identified earlier. This can continue on until a last, nth hidden layer 425 hₙ continues this abstraction process, allowing the network to recognize even higher-level, more detailed features, such as identifying an entire object within an image or understanding intricate relationships in the input data.

Each hidden layer adds a level of complexity and abstraction to the network's learning capabilities. The multi-layer structure can enable the network to move from recognizing simple patterns in the first input layer 421 to highly complex, abstract concepts in the deeper layers. The number of hidden layers and neurons within them can vary depending on the problem's complexity. More hidden layers generally allow the network to model more intricate functions, making deep neural networks especially effective for tasks like image recognition, natural language processing, and complex predictive modeling. However, adding more layers also increases the computational demand and the risk of overfitting, highlighting the need to carefully design and tune these hidden layers for optimal performance.

In various embodiments, the output layer 430 is often the final layer in a neural network and is responsible for producing the network's predictions or classifications based on the information processed through the previous hidden layers 420. Each neuron in the output layer 430 can represent a specific outcome or category that the model can predict. In the embodiment depicted in FIG. 4, the outputs are labeled as “output 1” to “output n,” indicating that the network can be designed to have a varying number of outputs depending on the nature of the problem being solved for. For example, in a binary classification task (e.g., an email is spam vs. an email is safe), there would typically be a single output neuron that provides a probability score for one of the two classes/outcomes. In contrast, for multi-class classification (e.g., determining an optimal path from many to transmit data), the output layer would contain multiple neurons, each corresponding to a different class.

The number of neurons in the output layer 430 can also designed specifically for other types of tasks, such as regression, where the model can predict continuous values. In such cases, the output layer 430 might contain a single neuron representing a numerical prediction, such as the price of a house or the temperature forecast, etc. Alternatively, in complex applications like multi-label classification (where each input can belong to multiple classes simultaneously), the output layer 430 could have multiple neurons, each representing a different class, with each neuron outputting a probability of the input belonging to that specific class.

The activation function used in the output layer can vary based on the desired output. For binary classification, a sigmoid function is commonly used to produce a probability between 0 and 1. For multi-class classifications, a SoftMax function can be applied to output a set of probabilities that sum to 1, indicating the most likely class. For regression problems, a linear activation function is often used to output a continuous range of values. The flexibility in designing the output layer allows the neural network 400 to be applied to a wide variety of tasks, from simple binary decisions to complex multi-output predictions, making them a versatile tool in artificial intelligence and machine learning.

Although a specific embodiment for an exemplary neural network suitable for carrying out the various steps, processes, methods, and operations described herein is discussed with respect to FIG. 4, any of a variety of systems and/or processes may be utilized in accordance with embodiments of the disclosure. For example, real-world neural networks are often far more complex, featuring many more layers, nodes, and connections than the simplified structure shown in the embodiment depicted in FIG. 4, which is an illustrative example meant to make it easier to explain the basic concepts of neural networks and how they process information. The specific features and functions described herein are not intended to be limiting to this specific embodiment. Additionally, the elements depicted in FIG. 4 may also be interchangeable with other elements of FIGS. 1-3 and 5-10 as required to realize a particularly desired embodiment.

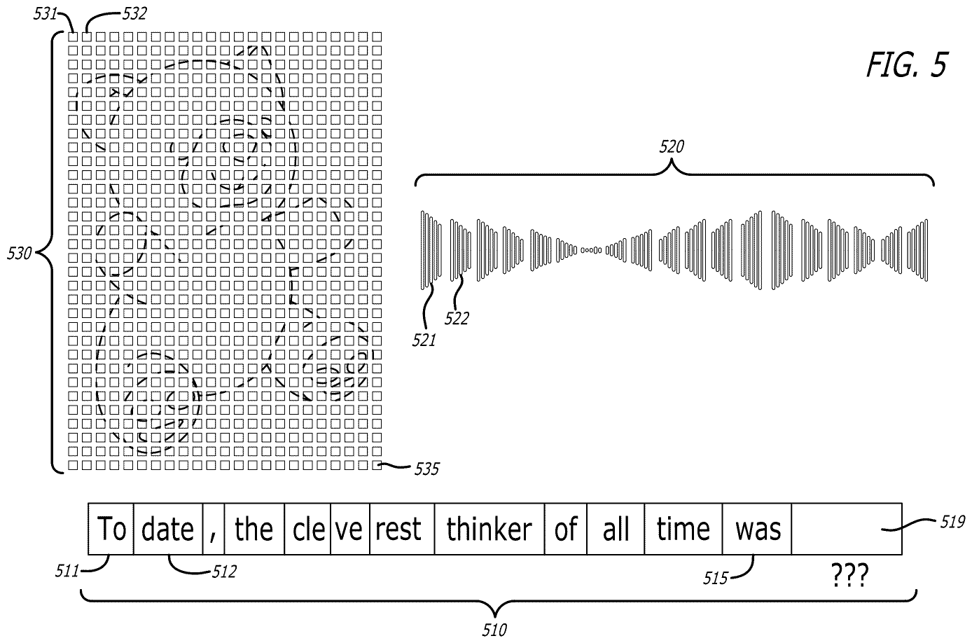

Referring to FIG. 5, a conceptual illustration of a variety of tokens for utilization within a large language model in accordance with various embodiments of the disclosure is shown. While most people are familiar with typing commands directly into a computer, interacting with a large language model (LLM) typically involves using prompts that are broken down into smaller units called tokens. These tokens can be segments of the original input prompt, such as individual words, subwords, or characters, allowing the model to process the prompt in manageable, structured pieces for a more nuanced understanding.

In fact, tokens are most often a fundamental unit of data used to represent a larger, general input for large language models (LLMs) and similar AI systems. In the context of LLMs, tokens are segments of text derived from the input prompt, where each token represents a manageable piece of the input, such as a word, part of a word, or a character. This segmentation can allow the model to break down complex text into simpler, consistent units that can be processed independently and then understood in relation to each other. By dividing input data into tokens, LLMs can handle language in a structured, flexible manner, adapting to diverse text inputs, from full sentences to specialized jargon or short phrases.

In many embodiments, tokens can serve as building blocks, enabling models to interpret language by analyzing these discrete parts and their relationships. For instance, in English, tokens often correspond to whole words, but when dealing with specialized vocabulary, slang, or languages with compound words, tokens might represent subwords or even single characters. This tokenization approach helps to maintain a balance between flexibility and precision, as smaller tokens allow the model to handle unfamiliar or highly specific terms more effectively. In a number of embodiments, each token can be encoded with a unique identifier that the model can use to differentiate it from others, preserving the distinct meaning or function it carries in context.

In the embodiment depicted in FIG. 5, a textual input prompt 510 is shown as divided up into a plurality of tokens. A first token 511 includes the word “To” while a second token comprises the next word “date”. In some embodiments, the first token 511 can be configured to include the space between “To” and “date”. This small change can be utilized by the LLM to further divine meaning from the textual input prompt 510. The number of tokens can vary depending on the type of input provided. This can extend from the first token 511 to the nth or last token 515 within the textual input prompt 510. This last token 519 can be utilized to indicate a requested or projected response 519.

Beyond text, similar tokenization principles may apply to other data types when used in models that process audio or visual input. For audio data, tokenization can involve dividing a sound file into slices, where each token might represent a short segment of audio, perhaps a fraction of a second or a small, meaningful slice of a larger waveform. By breaking audio down in this way, the model can analyze specific sounds, pitches, or rhythms within the context of the entire recording. This segmentation enables the model to interpret audio inputs in a structured format, similar to how language is tokenized, making it easier to process complex auditory patterns and understand sounds in a sequential manner.

In the embodiment depicted in FIG. 5, the audio input prompt 520 is shown divided into a plurality of audio slices. The first audio token 521 comprises a number of samples within the audio input prompt 520. Likewise, the second audio token 522 comprises a second number of samples within the audio input prompt 520. This slicing of the audio input prompt 520 can continue throughout the rest of the remaining audio such that when all tokens have been processed, the system can determine a best guess for the next audio token that should be appended to the end of the audio input prompt 520.

In the case of visual data, such as images, tokenization often involves segmenting the image into smaller chunks or patches, each of which becomes a visual token. These tokens represent different parts of the image, like color regions, edges, or textures, which the model can examine individually. Visual tokens enable the model to capture the intricate details within an image by focusing on manageable portions, while still considering their relationships to the broader visual structure. This approach allows AI systems to interpret complex images by analyzing these visual segments in the same way LLMs handle text tokens, offering a structured method for processing and understanding visual content.

In the embodiment depicted in FIG. 5, the image data prompt 530 is divided into a plurality of smaller visual tokens. The first visual input token 531 is shown as a small square portion of the original, larger image. This procedure of processing various chunks of the original image data prompt 530 can occur on these smaller portions of the image, such as the second visual input token 531, up to an including the nth visual input token 539. Each of these smaller visual tokens can be processed individually, but often in parallel to each other.

The concept of tokens is therefore versatile, allowing diverse types of input, whether text, sound, or images, to be converted into standardized, model-friendly formats. Tokenization creates a consistent framework for representing complex data types in a way that artificial intelligence systems can process effectively. This segmentation enables each model, regardless of the input type, to dissect and examine different parts of the data with a fine level of granularity, which is especially important when working with highly detailed or nuanced inputs. This tokenized structure can enable the model to interpret the input systematically, providing a foundation for further processing and understanding of the information encapsulated within each token.

Although a specific embodiment for a variety of tokens for utilization within a large language model suitable for carrying out the various steps, processes, methods, and operations described herein is discussed with respect to FIG. 5, any of a variety of systems and/or processes may be utilized in accordance with embodiments of the disclosure. In many non-limiting examples, the type and number of tokens can vary depending on the specific application desired and/or the amount of available processing power available to handle the input prompt. The elements depicted in FIG. 5 may also be interchangeable with other elements of FIGS. 1-4 and 6-9 as required to realize a particularly desired embodiment.

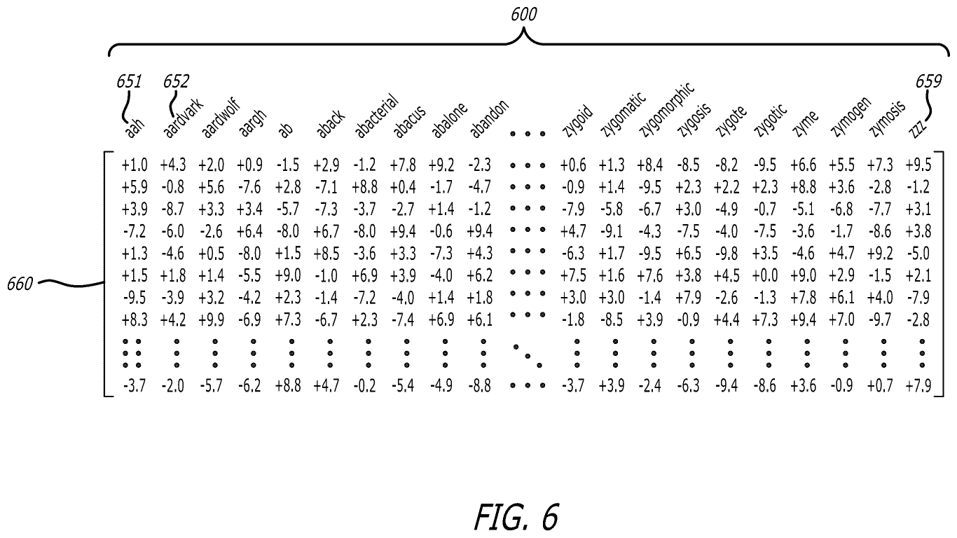

Referring to FIG. 6, a conceptual illustration of an embedding matrix 600 for a large language model, in accordance with various embodiments of the disclosure is shown. In many embodiments of large language models (LLMs), embedding matrices are components that enable the model to interpret tokens in a mathematically accessible way. An embedding matrix 600 is essentially a large table of vector representations, where each token in the model's vocabulary is assigned a unique vector, or array of numbers, that captures its initial meaning in relation to other tokens. When an input prompt is tokenized, each token can be matched with a corresponding entry in the embedding matrix 600. In a number of embodiments, this lookup process can provide the token with an initial value, or embedding, which represents the token in a multi-dimensional space. These embeddings allow the model to recognize patterns, relationships, and meanings in language beyond simple string matching, forming the foundation for all further processing within the model.

In a number of embodiments, each entry in the embedding matrix 600 is a vector of fixed size, with each dimension in the vector representing a distinct feature or aspect of the token's meaning. For example, words that are semantically or contextually similar may have embeddings that place them close to one another in this multi-dimensional space. This spatial relationship allows the model to capture a form of conceptual proximity wherein synonyms or related terms might occupy nearby areas in this space, while antonyms or unrelated words are farther apart. By assigning each token an embedding with specific values, the matrix can encode subtle linguistic and contextual information into numerical form, enabling the model to work with tokens in a highly structured, yet flexible, manner.

In the embodiment depicted in FIG. 6, the embedding matrix 600 is associated with every known word in the English language. In other words, the matrix has a column associated with each of the around 50,000 or so words in English. Each column of the embedding matrix 600 comprises a vector 660 which associates the corresponding word to a location with a multi-dimensional space. For example, the first word 651 “aah” has a corresponding vector 660 from the first entry +1.0, to the nth entry −3.7. Likewise, the second word 652 “aardvark” has another column of vector values associated with it starting at +4.3 and ending in −2.0. Finally, the nth word 659 “zzz” is associated with a corresponding vector 660 that includes the values in the column starting at +9.5 to +7.9. As each token is processed, it is assigned the corresponding vector 660 taken from the embedding matrix 600.

The embedding matrix 600 is typically learned during the model's training phase. As the model is exposed to vast amounts of text, it iteratively adjusts the values in the embedding vectors to capture the relationships between tokens more accurately. Through this process, embeddings evolve to represent the associations, contexts, and distinctions that the model has observed across its training data. For instance, words that frequently appear together or in similar contexts may have embeddings that reflect this association. The embedding matrix 600 thus serves as a kind of “knowledge base” for initial token relationships, giving the model a structured way to approach the vast variability in language.

This embedding approach is highly efficient because it enables the model to generalize across contexts and recognize similarities even with previously unseen tokens. For example, even if a token or phrase in a prompt has not been encountered during training, the model can infer its meaning based on the embeddings of other, similar tokens. This generalization is possible because embeddings capture both specific meanings and broader patterns, allowing the model to interpret novel inputs based on its learned understanding of language structure and relationships. By embedding tokens in a shared space, the model can gain a foundational understanding of language that it can apply across various prompts and contexts. This arrangement can allow the LLM to move beyond a rigid, word-by-word interpretation and instead engage with language as a rich network of interconnected meanings and ideas.

Although a specific embodiment for an embedding matrix for a large language model suitable for carrying out the various steps, processes, methods, and operations described herein is discussed with respect to FIG. 6, any of a variety of systems and/or processes may be utilized in accordance with embodiments of the disclosure. For example, similar concepts associated with the embedding matrix 600 of FIG. 6 can be applied to other types of embedded matrices associated with other data types. It is contemplated that the embedding matrix is only limited by the types of input data that it is configured to process. The elements depicted in FIG. 6 may also be interchangeable with other elements of FIGS. 1-5 and FIGS. 7-9 as required to realize a particularly desired embodiment.

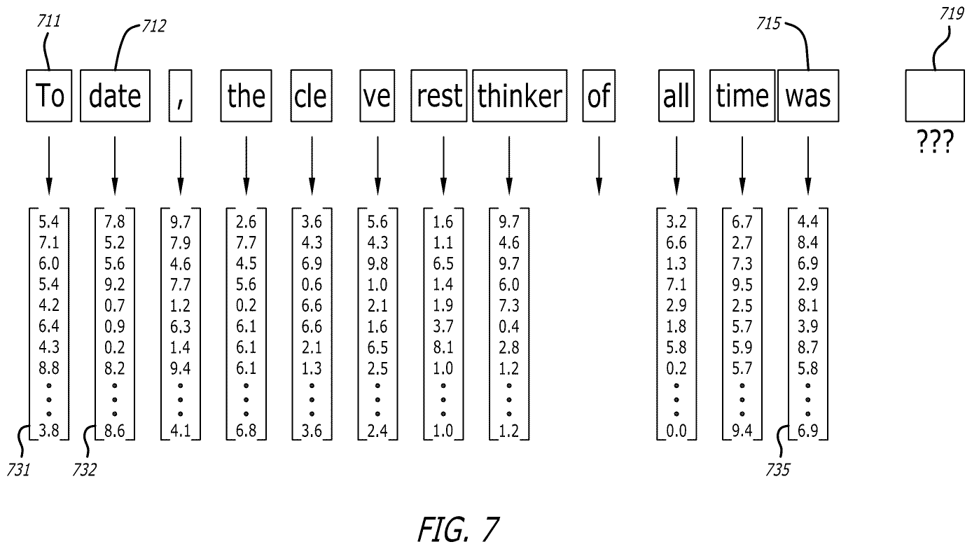

Referring to FIG. 7, a conceptual illustration of an input prompt converted from a series of tokens into a series of tensors in accordance with various embodiments of the disclosure is shown. In many embodiments, when an input prompt is converted into tokens, each of these tokens is then transformed through an embedding matrix to yield a unique vector representation, known as an embedding. This embedding is often a numerical array, or tensor, that encodes the token's position, context, and meaning within a multi-dimensional space. Essentially, once the tokenized prompt passes through the embedding matrix, each token is matched with a tensor that captures both its individual characteristics and its relationships to other tokens in the model's vocabulary. These tensors form the foundational representation of the prompt, providing structured data that the model can process to understand and generate contextually relevant responses.

Each tensor associated with a token after embedding can represent a fixed number of dimensions, often hundreds or even thousands, depending on the model's architecture. These dimensions give the tensor a rich structure, with each element in the tensor reflecting different features of the token's meaning. For instance, certain dimensions might encode aspects related to semantic similarity, part of speech, or contextual nuances observed during training. By encoding these complex features into a tensor, the model gains a detailed, flexible understanding of the token's role in the input prompt, which becomes critical for capturing context, sentiment, and intent in language processing tasks.

In various embodiments, the collection of tensors generated from the embedded tokens can create a high-dimensional representation of the entire prompt, with each tensor holding a unique set of values corresponding to its specific token. Because each tensor encodes information about a single token, the model can recognize patterns in the prompt by examining the relationships between these tensors. For example, words that often appear together may have similar values in certain dimensions of their tensors, allowing the model to capture implicit relationships and context within the input. This organized structure of tensors provides the model with a map of the prompt that it can analyze to make inferences about meaning, order, and emphasis.

In the embodiment depicted in FIG. 7, the first token 711 is associated with the word “To” and has a corresponding tensor 731 which is an array in multi-dimensional space. Likewise, the second token 712 is associated with a second tensor 732. Each token within the input prompt is subsequently associated with a corresponding tensor, up to the last and nth token 715 which is associated with the nth tensor 735. Processing these input prompt tokens will yield a projected or otherwise best fit for what the next token/word 719 will be.

In further embodiments, the use of tensors can allow the model to handle complex language structures efficiently, as each token's tensor can interact with others in ways that reflect natural language dependencies. By representing each token as a tensor, the model can apply various mathematical operations across these tensors to analyze and synthesize information. These operations enable the model to determine which tokens are most relevant to one another within the context of the prompt. For instance, determining the vector difference between two related words like “man” and “woman” may be applied to a different context to determine similar words like applying that same vector difference to the vector associated with “uncle” to lead to the vector associated with the word “aunt”.

Although a specific embodiment for an input prompt converted from a series of tokens into a series of tensors suitable for carrying out the various steps, processes, methods, and operations described herein is discussed with respect to FIG. 7, any of a variety of systems and/or processes may be utilized in accordance with embodiments of the disclosure. For example, the number of elements within a tensor can number in the thousands, or even tens of thousands, depending on the complexity of the model. Additionally, in various embodiments, the position of the token within the input prompt can also be encoded within the tensor, which may be done by processing some additional value to the original tensor. The elements depicted in FIG. 7 may also be interchangeable with other elements of FIGS. 1-6 and FIGS. 8-10 as required to realize a particularly desired embodiment.

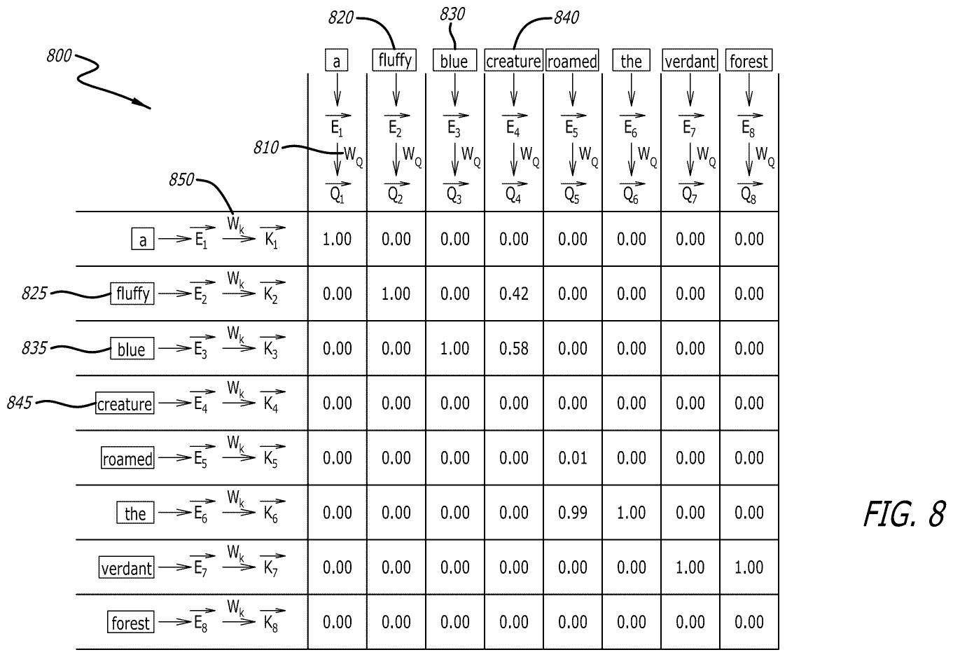

Referring to FIG. 8, a conceptual illustration of an attention layer process 800 within a large language model in accordance with various embodiments of the disclosure is shown. When processing languages such as English, understanding the context of each word or token within an input prompt is beneficial. As such, many embodiments herein comprise at least one attention layer for processing the embedded tokens.

Take for example, the following three sentences: “I saw an American shrew mole,” “Measure one mole of carbon dioxide,” and “Take a biopsy of that mole”. Each of these sentences utilize the word “mole” in distinct contexts, demonstrating how language can carry multiple meanings based on surrounding words and phrases. In natural language processing, understanding these varied meanings requires the model to consider each token in relation to its neighbors, which is where attention layers become crucial. By focusing on the surrounding context of each instance of “mole,” an attention layer can discern whether it refers to an animal, a unit of chemical measurement, or a skin lesion. In many embodiments, the context, or set of nearby tokens, can allow the model to assign different meanings to “mole” depending on which other words are present, such as “American shrew” in the first case, “carbon dioxide” in the second, and “biopsy” in the third.

In a number of embodiments, attention layers can enable the model to weigh the relevance of each neighboring token to identify the specific meaning of “mole” in each phrase. For example, in “An American shrew mole,” the attention mechanism can emphasize the tokens “American” and “shrew,” which typically appear in contexts related to animals, thus guiding the model to interpret “mole” as a small mammal. Conversely, for the phrase “One mole of carbon dioxide,” however, the presence of “carbon dioxide” and the numerical term “one” shifts the focus toward scientific terminology, signaling that “mole” refers to a unit of chemical measurement. Similarly, in “Take a biopsy of that mole,” attention is drawn to the medical term “biopsy,” leading the model to interpret “mole” as a skin lesion. Through this mechanism, attention layers allow the model to dynamically adapt its understanding of words based on context, handling polysemous terms (words with multiple meanings) with greater accuracy.

In this way, attention layers can help the model “tease out” the correct meanings by selectively focusing on relevant tokens within the prompt. By assigning higher weights to contextually significant words, the model can make nuanced distinctions between different senses of the same token. This ability to disambiguate words based on context is essential for LLMs to generate accurate and meaningful responses, as it enables them to navigate the inherent complexity and flexibility of human language.

In literature, the generation of “attention” with these attention layers is described as:

$$Attention ( Q , K , V ) = softmax ( \frac{Q {K}^{T}}{\sqrt{{d}_{k}}} ) V$$

Wherein Q represents the query matrix which itself is a placeholder for the “query” vectors derived from each embedded token in the input sequence. When processing language, each token (or word) is associated with a specific query vector that encodes what that token is “looking for” in other tokens within the sequence. In many embodiments, these query vectors are produced by multiplying the token embeddings by a learned weight matrix specific to the queries. The query serves as a way for the model to actively seek out relevant information from other tokens, allowing it to identify connections or dependencies between different parts of the sequence. Thus, queries capture the intention or focus of each token as it interacts with the rest of the input.

K is associated with the key matrix consisting of “key” vectors, which are similarly derived from the input sequence. Each token has an associated key vector that represents the essential information it holds. While queries represent what each token is searching for, keys encode what each token offers in terms of information. Keys are generated by multiplying token embeddings with a learned weight matrix distinct from that used for queries. The relationship between queries and keys determines how strongly one token will attend to another, allowing the model to weigh the relevance of each token to each other token within the sequence.

The term QK^{T} therefore represents the dot product between the query and key matrices. This operation calculates the similarity (or relevance) between each query vector and each key vector, effectively measuring how much attention one token should give to another. The resulting score indicates how strongly each token should focus on every other token, capturing the relationships within the input sequence. This relevance score is fundamental to the attention mechanism, as it serves as the basis for distributing focus across the sequence.

Within the above equation, V stands for “value”, insomuch as a value matrix contains “value” vectors, which can represent the actual content information associated with each token. Unlike queries and keys, which often work to determine the relevance of tokens to each other, values contain the data the model will pass along through the attention layer. Value vectors are produced by multiplying token embeddings with a learned weight matrix specific to values. These value vectors carry the contextual information that the model will use when constructing output, ensuring that the information emphasized by the attention mechanism is carried forward in processing.

The division by \sqrt{dₖ} is a scaling factor where dₖ denotes the dimensionality of the query and key vectors. Without this scaling, the dot product values in QK^{T} could become large as the number of dimensions increases, which would push the SoftMax function towards extreme values, creating an unstable learning process. By scaling with \sqrt{dₖ}, the model normalizes the scores, keeping gradients more manageable and stabilizing the SoftMax output, which aids in more effective learning and model convergence.

In the embodiment depicted in FIG. 8, an input prompt of “a fluffy blue creature roamed the verdant forest” is being processed through the attention filter 800. Each of these tokens, such as the first token 810 are subject to processing through a query vector 810 shown as W_{Q}. In a very simplistic way (and described herein for illustrative purposes), the token has an associated query vector 810 that can “ask” questions in a numerical way such as, but not limited to, “are there any adjectives in front of me”? In response, words that are adjectives before the creature token 840 are more likely to be activated later on.

Specifically, each token has an associated vector/tensor written down herein as E₁, E₂ onward to E₈. Each of these vectors/tensors can be multiplied by or otherwise processed by a corresponding query matrix (shown as W_{Q}) to generate a query vector, denoted by Q₁, Q₂ onward to Q₈. Likewise, the same tokens, such as the first key token 825, second key token 835, and fourth key token 845 can be processed through a key matrix (shown as Wₖ) to generate a corresponding key vectors denoted by K₁, K₂, and the like. Finally, for each token, the dot product of the query vector and key vector are determined. These values are then operated on through a type of SoftMax filter to generate a specific format of numbers such that each value will be placed between 0 and 1, and the sum off all values within a column shall be equal to 1. In this way, we can see that the “fluffy” token 820 and “blue” token 830 output a large value in association with the token “creature” as those tokens are adjectives describing the creature token 840. Similar values appear when “the” and “verdant” are compared to the token “forest”.

In a variety of embodiments, the result of this dot product is an “attention vector” that can be added to the original vector such that a new modified attention vector is created. The goal is to move the vector associated with the token to a spot on the multi-dimensional space that is closer to other related terms. This output can then be sent to one or more multi-layer perceptron (MLPs).

Although a specific embodiment for an attention layer process 800 within a large language model suitable for carrying out the various steps, processes, methods, and operations described herein is discussed with respect to FIG. 8, any of a variety of systems and/or processes may be utilized in accordance with embodiments of the disclosure. For example, the process described herein with reference to FIG. 8 and the attention models is presented in a simplistic fashion in order to allow for increased comprehension. However, those skilled in the art would recognize that other steps or attention model types may be utilized such as, but not limited to multi-head attention, and multi-head attention. The elements depicted in FIG. 8 may also be interchangeable with other elements of FIGS. 1-7 and FIG. 9-10 as required to realize a particularly desired embodiment.

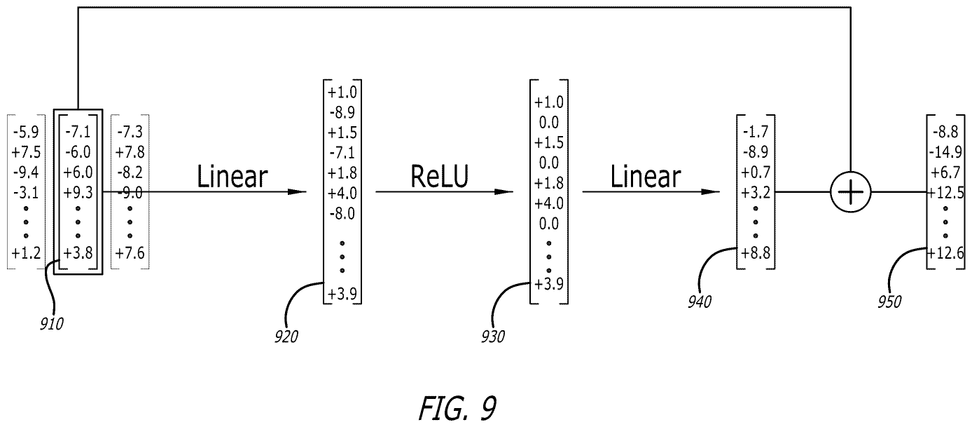

Referring to FIG. 9, a conceptual illustration of a multi-layer perceptron within a large language model in accordance with various embodiments of the disclosure is shown. In many embodiments within large language models (LLMs), multi-layer perceptrons (MLPs) play a role in refining and processing information after it has passed through the attention layers. MLPs, in the context of LLMs, are often positioned after each attention layer to add further transformations to the information embedded within each token. After the attention layer has modified each token's vector based on context and relationships with other tokens, this modified vector is then passed through an MLP. This MLP typically consists of a sequence of linear transformations, combined with a non-linear activation function, such as ReLU (Rectified Linear Unit). By applying these transformations, the MLP can help to fine-tune the representation of each token, capturing essential details and storing “factual” information that the model may rely on later.

The process can begin with a linear transformation, which expands the dimensions of the modified vector 910, essentially mapping it to a higher-dimensional space. In the embodiment depicted in FIG. 9, the original modified vector 910, which is typically an output of an attention layer, is processed through a linear transformation to yield a first output vector 920. This initial expansion can allow the MLP to encode more complex information within each vector, giving it more capacity to capture and retain meaningful details.

After this expansion, various embodiments can apply a ReLU activation function, which introduces non-linearity into the processing. ReLU is particularly effective because it enables the model to focus on positive values within the vector, setting any negative values to zero. This step allows the model to highlight certain features within the token's vector while suppressing others, helping it differentiate important from less relevant information within the encoded representation. In the embodiment depicted in FIG. 9, the ReLU output vector 930 is subsequently processed through another linear transformation.

In a number of embodiments, this second linear transformation can down-project the vector back to its original dimensionality. This step can ensure that the output from the MLP has the same dimensions as the input vector, allowing for a consistent vector size across all layers. The output vector 940 from this down-projection is then added back to the original modified vector from the attention layer, creating what's known as a residual connection 950. This residual connection 950 combines the newly refined features from the MLP with the original contextual information produced by the attention layer. This approach enhances stability during training and allows the model to retain both the relational context and the refined factual details within the token's representation.

In the broader architecture of LLMs, MLPs are often considered the component where “facts” are stored. While the attention mechanism focuses on identifying relationships and associations between tokens, essentially, contextualizing each word within the sentence structure, the MLPs focus on enriching each token's representation with more granular, content-specific details. Through the repeated application of MLPs across multiple layers, the model can accumulate and consolidate information, effectively “remembering” facts and attributes associated with different words or phrases. This allows LLMs to recall specifics about language usage, word meanings, and even broader real-world information encoded in the training data.

In contrast, the attention layers are where the “associations” are stored, focusing on dynamically adjusting each token's focus depending on its context within the input sequence. Attention layers determine how strongly each token should relate to others, capturing nuances like syntax, grammar, and context-sensitive meanings. While attention layers dynamically build context, MLPs hold onto factual representations that serve as the knowledge base within each layer. Together, the attention and MLP layers enable the model to balance understanding relationships with retaining concrete information, resulting in a robust representation of both context and knowledge.

In a number of embodiments, input data often passes through multiple rounds of attention filters and multi-layer perceptron (MLP) layers, forming a sequence of transformations that incrementally refine the model's understanding of the input before reaching the final output stage. Each layer in the transformer model, the architecture commonly used for LLMs, includes both an attention component and an MLP component, with these two parts working in tandem to progressively deepen the model's comprehension of the text. This sequence is repeated over numerous layers, allowing the model to develop a sophisticated representation of the entire input sequence through cumulative transformations. By the end of these repeated passes, each token vector holds a highly nuanced, multi-dimensional understanding of the prompt. Once all layers have processed the data, the final, refined vectors proceed to the unembedding stage, where they are mapped back to language tokens that represent the model's predicted output.

Although a specific embodiment for a multi-layer perceptron within a large language model suitable for carrying out the various steps, processes, methods, and operations described herein is discussed with respect to FIG. 9, any of a variety of systems and/or processes may be utilized in accordance with embodiments of the disclosure. For example, as those skilled in the art will recognize, the specific layout and structure of the MLP layer can vary depending on the specific application desired. The elements depicted in FIG. 9 may also be interchangeable with other elements of FIGS. 1-8 and 10 as required to realize a particularly desired embodiment.

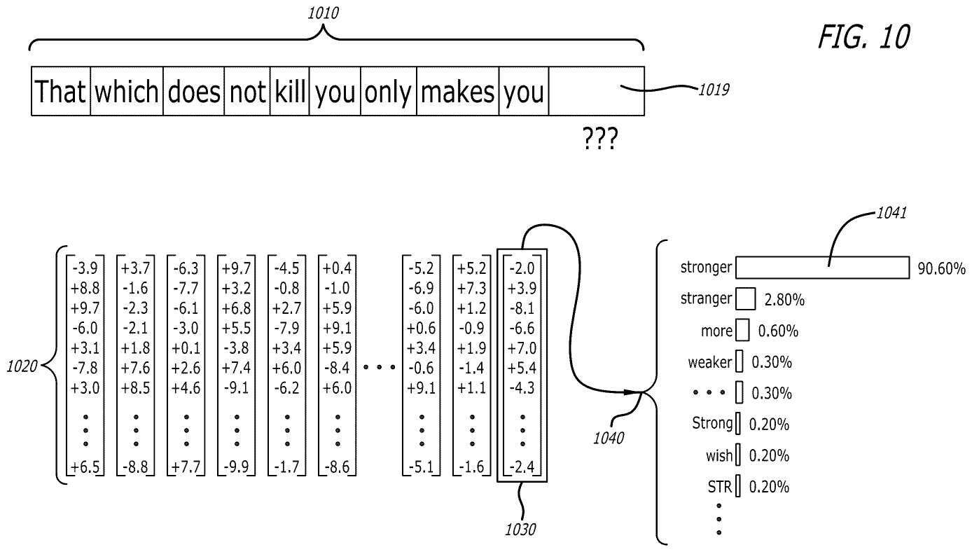

Referring to FIG. 10, a conceptual illustration of an unembedding process within a large language model in accordance with various embodiments of the disclosure is shown. In many embodiments, the final stage of a large language model's (LLM) processing is called unembedding, where it transforms the refined vectors from the last layer back into a probability distribution over potential output tokens. This stage is useful because it can allow the model to generate language tokens that represent the most likely continuations or responses to the input prompt. To achieve this, each vector (representing a token in the sequence) is mapped back to the model's vocabulary, which may contain tens of thousands of possible tokens. Unembedding utilizes a learned matrix, similar to the embedding matrix used at the input stage, but in reverse. Instead of converting tokens into vectors, it translates the processed vectors back into a set of potential language tokens that the model can output.

In a number of embodiments, the matrix output 1020 from the unembedding process is a final array 1030 where each entry corresponds to a probability score for a potential token. This probability distribution indicates how likely each word or phrase is to follow the input sequence, based on the context the model has built through its layers of attention and MLP processing. For instance, if the input prompt 1010, such as in the embodiment depicted in FIG. 10, is “That which does not kill you only makes you,” the unembedding process will produce a ranked list of possible next words. In this case, the word “stronger” might appear as the most probable continuation, with a high probability score. In FIG. 10, the probability of the “stronger” token response 1041 within the list of possible token responses 1040 is shown as 90.60 percent. This reflects the model's understanding of common phraseology and context, identifying “stronger” as a likely completion due to its frequency and relevance in similar contexts within the training data.

The ranked list produced during unembedding may include other potential outputs, each with an associated probability score that indicates its relative likelihood. For example, the word “stranger” could appear as a less probable continuation, with a probability of 2.80 percent, still present in the ranked list but much lower than “stronger.” This ranking reflects the model's capacity to recognize alternative continuations, including those that might follow less conventional but still possible language patterns. Other words, such as “more” or “weaker,” may also appear on this list, each with its own probability based on the contextual and semantic associations the model has learned. This probabilistic approach allows the model to produce flexible responses and make informed guesses about the next token in a way that mimics human language prediction.

The unembedding process may not only provide a ranked list of potential next words but also enable the model to maintain flexibility in generating responses. Depending on the application, the model might choose the highest-ranked token for a precise and likely output, or it could sample from the probability distribution to introduce variability, which can be useful in creative text generation or conversational applications. By examining the distribution of probabilities across potential tokens, the model can adapt its output strategy to different tasks, choosing the most probable word for accuracy or exploring lesser probable options for creative responses. This versatility is one of the reasons LLMs are effective across diverse language tasks, from completing sentences to generating open-ended stories.

The probability distribution generated in the unembedding phase reflects the culmination of all previous processing steps, encapsulating the context, associations, and factual information encoded within the model. Each token's probability is informed by the layers of attention and MLP transformations, which allow the model to build a nuanced understanding of the input. By ranking potential outputs, the model can provide a final “decision” on the next token based on its understanding, with the unembedding process acting as a bridge between the abstract, high-dimensional vector space within the model and the concrete language output we see.

In further embodiments, the LLM can generate entire sequences of text by using its own output as the input for subsequent steps, allowing it to create a series of tokens that form coherent responses or passages. Once the model generates a probable next token, it can feed this token back into its input pipeline, treating it as the next part of the prompt. This iterative process enables the model to build on each newly generated token, maintaining continuity and context with each step. For example, if the initial prompt is “The sky is,” and the model predicts “blue” as the most probable next word, it can then take “The sky is blue” as the new input. By repeating this cycle, the LLM can produce extended responses, updating its understanding of context and adjusting its predictions as it goes along. This feedback loop allows the model to generate complex, contextually aligned sequences, whether for completing sentences, generating stories, or engaging in conversational responses, all by sequentially predicting and incorporating each token into its evolving context.

Although a specific embodiment for an unembedding process within a large language model suitable for carrying out the various steps, processes, methods, and operations described herein is discussed with respect to FIG. 10, any of a variety of systems and/or processes may be utilized in accordance with embodiments of the disclosure. For example, the output for other types of models can be token related to images, sounds, or other data format types. The elements depicted in FIG. 10 may also be interchangeable with other elements of FIGS. 1-9 as required to realize a particularly desired embodiment.

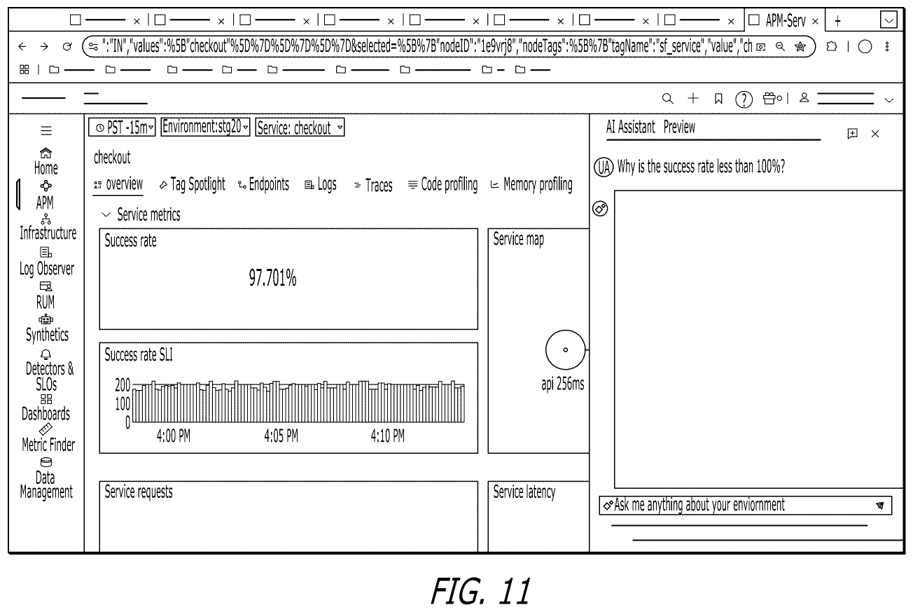

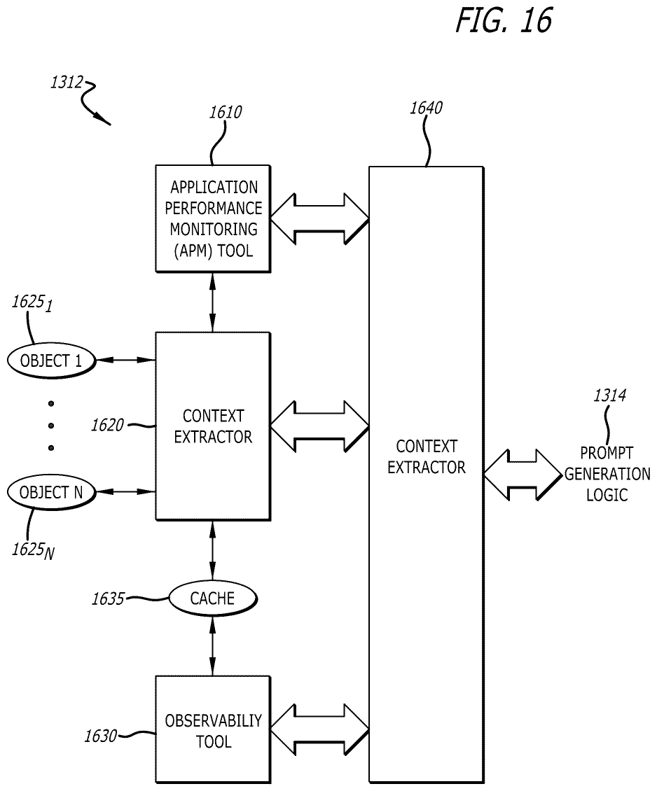

FIG. 11 is an example web page including a chat interface (or chatbot interface) displayed in a web browser application on a networking device in accordance with various embodiments of the disclosure. The example web page illustrates an AI-assisted inquiry session with the LLM by the AI Assistant application. The inquiry session with the LLM is facilitated by using a chatbot to simulate human conversation for efficient communication. Together with the AI Assistant, the overall system provides seamless and productive user experience. A chatbot incorporates several features that are useful for realistic human conversation. These features may incidentally be exploited by the AI Assistant to further enhance user experience by obtaining contextual information related to the user inquiry, e.g., obtaining contextual information to which the user question pertains. One example is the use of observability tools. This aspect will be described further in FIG. 16.

In the example shown in FIG. 11, the user is inquiring about monitoring results of a checkout service. The web browser application receives results from a monitoring application, such as an Application Performance Monitoring (APM), and displays the results. Among several items of the monitoring results, two items in the service metrics are shown: the average success rate and a plot of the success rates over time. The average success rate is 97.701% and the plot of the success rates is shown over a period of approximately 15 minutes. Suppose the user is curious about the success rate and wants to know more about it. The user may pose a question, “Why is the success rate less than 100%?” This question is then submitted to the LLM for response.

Without context or additional information, the LLM may not be able to provide a proper response because the answer may depend on several factors. A complete answer may require the LLM to go through all the factors or conditions, many of them are irrelevant or unnecessary to the user's particular interests. As an example, an answer to the above question without context may be as follows:

“To determine why the success rate is less than 100%, we need to analyze various factors that could contribute to this issue. This typically involves examining metrics related to errors, requests, and latency for the services in your environment. Here are the steps we can take to investigate:
1. Identify the Environment and Services: We need to know which environment and services are experiencing a lower success rate.
2. Analyze Service Errors and Requests: We can look into the breakdown of errors and requests for the services to identify any patterns or specific issues.
3. Examine Service Latency: High latency can sometimes lead to timeouts or failures, affecting the success rate.
4. Check Logs for Errors: Logs can provide detailed insights into specific errors or issues that are causing failures.
   Please provide the environment name and the specific service you are concerned about, so we can proceed with a detailed analysis.”

As seen from the above, the answer appears too long and incomplete. The user has to read the complete answer in order to procced. In addition, the user may not be able to proceed because he or she may be unfamiliar with the provisions of the application such as the environment name. Accordingly, an answer to a contextless inquiry may be tedious, incomplete, or contain a lot of irrelevant information. More importantly, such an answer may cause confusion to the user because the user may not be familiar with the various terminologies, conditions, or options. The result is an unproductive or frustrating user experience with the LLM.

A context-aware setting may be more productive and provide the user with a pleasant experience. In many cases, a contextualized inquiry may lead to a more accurate and complete reply. In addition, various embodiments of the disclosure provide security and safety measures to protect the system from intrusion or attack such as prompt injection attacks.

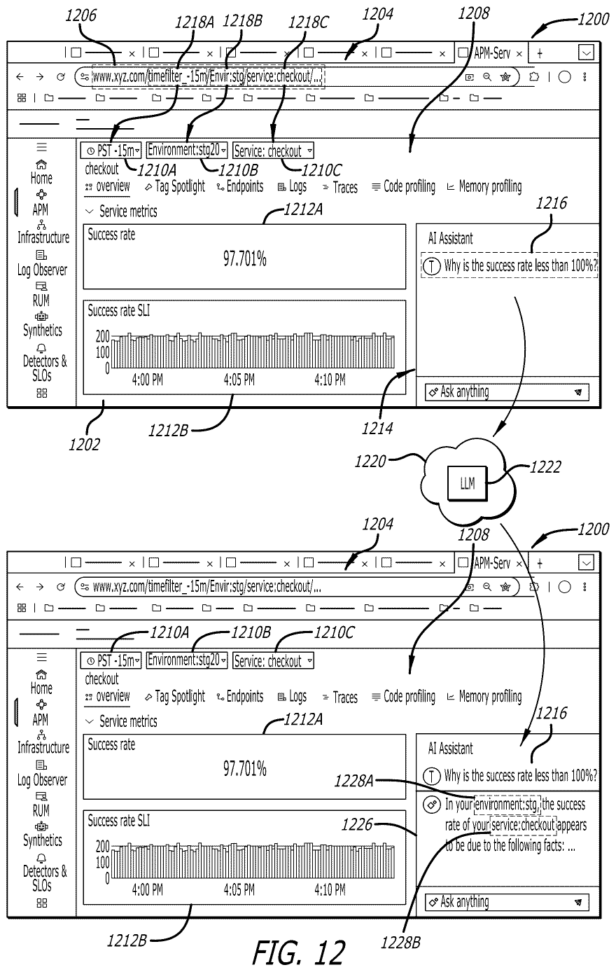

FIG. 12 is a conceptual illustration of a chat interface receiving a user input question for a large language model, obtaining context for the user input question from a web browser, and obtaining a prompt response for the large language model in accordance with various embodiments of the disclosure. The chat interface is part of a chatbot and is displayed on a display monitor (or display screen, e.g., a physical screen) of a network device 1200. A web browser 1202 returns a display area that includes an address bar 1204 displaying a URL 1206, web page body 1208 and a header portion that lists filters 1210A, 1210B, 1210C. The URL 1206 is shown to include terminology indicative of the filters 1210A, 1210B, 1210C, which are illustrated as URL components 1218A, 1218B, 1218C that corresponding to 1210A, 1210B, 1210C, respectively. As shown, the URL component 1218A refers to a time filter (e.g., one or more time restrictions), the URL component 1218B refers to a network environment filter, and the URL component 1218C refers to a service filter. The filter 1210A shows a time filter instance of 15 minutes. The filter 1210B shows an environment instance of: “stg,” which may be a name of an environment. The filter 1210C shows a service instance of checkout. Data display modules 1212A and 1212B are equipped with textual and graphic capabilities to show the results of the inquiry. As shown, the module 1212A shows, “Success Rate: 97.701%” and the module 1212B shows a plot of the success rate over a period of 15 minutes.

An AI chat interface 1214 provides a window that is configured to receive a user input question 1216 thereby enabling interaction between a user and the LLM 1222. The AI Assistant is configured to obtain context corresponding to the user input and provide the same to the LLM, which enables the LLM to fully and accurately respond to the user input question 1216. The user input will be combined with the context to form a prompt or a composite inquiry. In some examples, the inquiry text including the user input and the context is sent to an LLM 1222 in a cloud computing resource 1220. The LLM 1222 processes the text to obtain a response 1226 to the user input using the context. The LLM 1222 returns the response 1226 to the network device 1200, which is displayed in the window provided by the AI chat interface 1214. The window shows the user input question 1216 and an LLM response 1226 below the user input question 1216. The response 1226 includes items 1228A and 1228B which indicate aspects of the context of the prompt response were considered by the LLM 1222. In the example shown in FIG. 12, the response is:
“In our ‘environment: stg,’ the success rate of your ‘service: checkout’ appears to be due to the following facts: . . . ”

The item 1228A (“environment: stg”) and the item 1228B (“service: checkout”) are obtained from the context provider of the AI Assistant. This example illustrates that the relevant context is obtained without asking the user to provide the information. With the proper context, the response from the LLM is accurate and complete. The inquiry session does not require the user to enter any contextual information and automatically generates the relevant context to the prompt. This removes any effort from the user in formulating an inquiry that is tailored according to the user's preferences and interests. The result is an efficient and seamless inquiry-response session with the LLM that saves time for the user and provides an accurate and complete response.

Additionally, the LLM response 1226 may outline a set of one or more remediation measures, where the AI assistant may optionally automatically perform of one or more of the remediation measures. The remediation measures are typically dependent on the user input, the context corresponding to the user input, and a root cause of an issue. For example, when the root cause relates to a security measure such as unusual login attempts (such as brute-force login attempts, unauthorized access attempts, receipt of malware/phishing emails or network communications, data exfiltration, etc.) remediation measures may include blocking suspicious internet protocol (IP) addresses through a firewall or security information and event management (SIEM) system, requiring multi-factor authentication (MFA) for a subset of users, quarantining a subset of users' systems, accounts, or machines (such as preventing network traffic to or from a system, account, or machine believed to be affected), deleting or locking files suspected to be malicious, attempting to claw back an email or network communication, moving an email within a user's mail client to a spam or junk folder (and optionally notifying the user), perform an anomaly detection process involving processing of a file (email, attachment, download, script, etc.) considered suspicious or malicious within a virtual environment (e.g., sandbox analysis), etc.

When the issue relates to network performance or latency issues, the remediation measures recommended or automatically performed may include rerouting network traffic (e.g., through SD-WAN or load balancers), throttling or dropping suspicious traffic at firewalls, blocking suspicious or malicious IP address or domains at a firewall or SIEM system, restarting or reconnecting with unresponsive network services (e.g., VPN services, DNS servers, or proxies), etc. Additional remediation measures recommended or automatically performed may include automatically scaling (up or down) allocated compute resources to a particular accounts through provisioning or terminating EC2 instances, VMs, etc., deleting temporary files or log archives from a machine, reassigning workloads between nodes, reverting to a prior software version, etc.

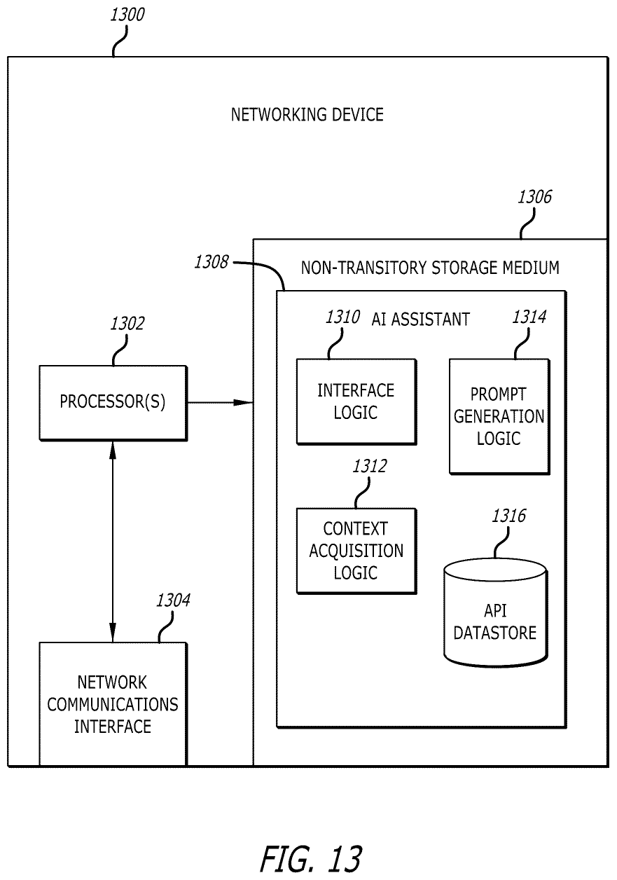

FIG. 13 is a logical representation of a network device 1300 having an artificial intelligence (AI) Assistant module 1308 in accordance with various embodiments of the disclosure. The network device 1300 includes a network communications interface 1304, one or more processors 1302 and a non-transitory storage medium 1306. The network device 1300 may include more or less than the above components.

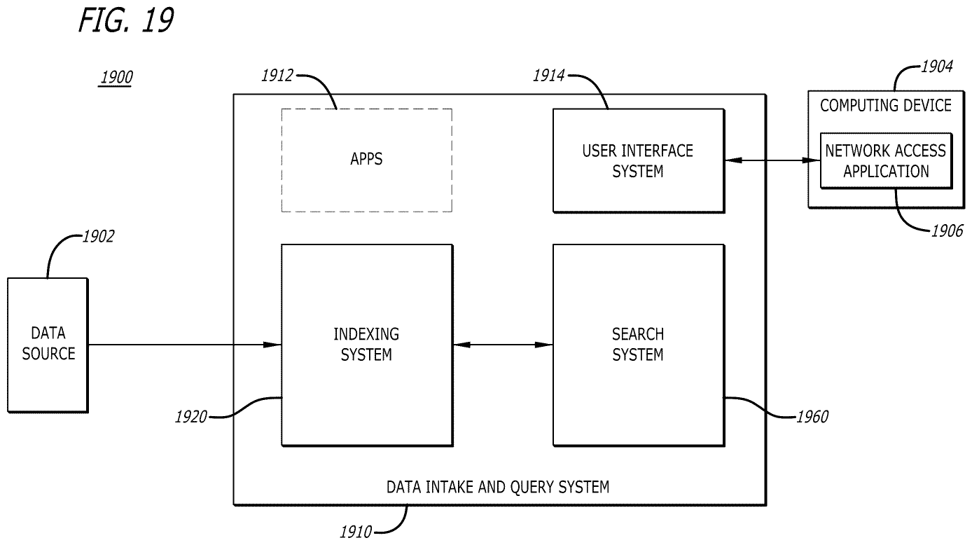

The network device 130 may be a computing device connected to a network via the network communications interface 1304 as described in FIGS. 19-22. The one or more processors 1302 may include a central processing unit (CPU), a graphics processing unit (GPU), a neural processing unit (NPU), an applications specific integrated circuit (ASIC), or any combination of these devices. The one or more processors 1302 may be configured to perform tasks or operations related to AI as described in various embodiments of the disclosure.

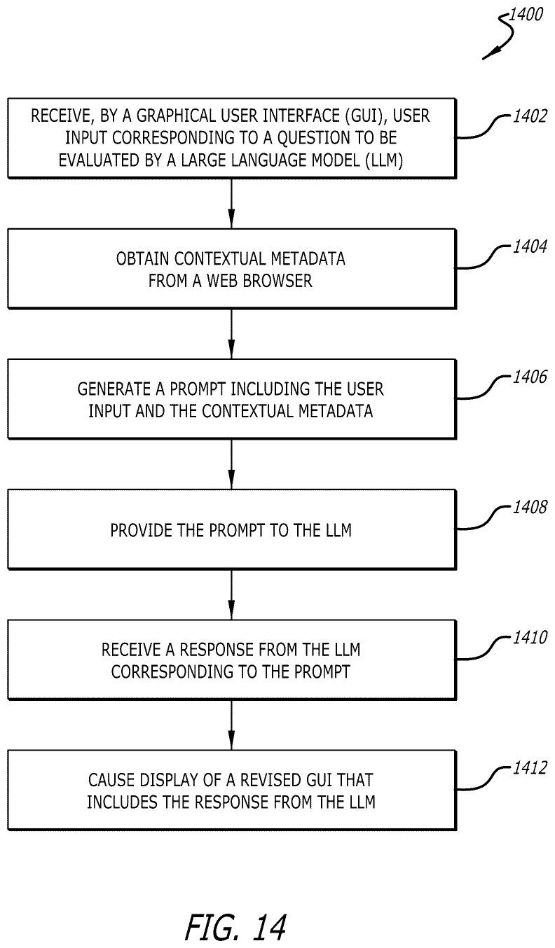

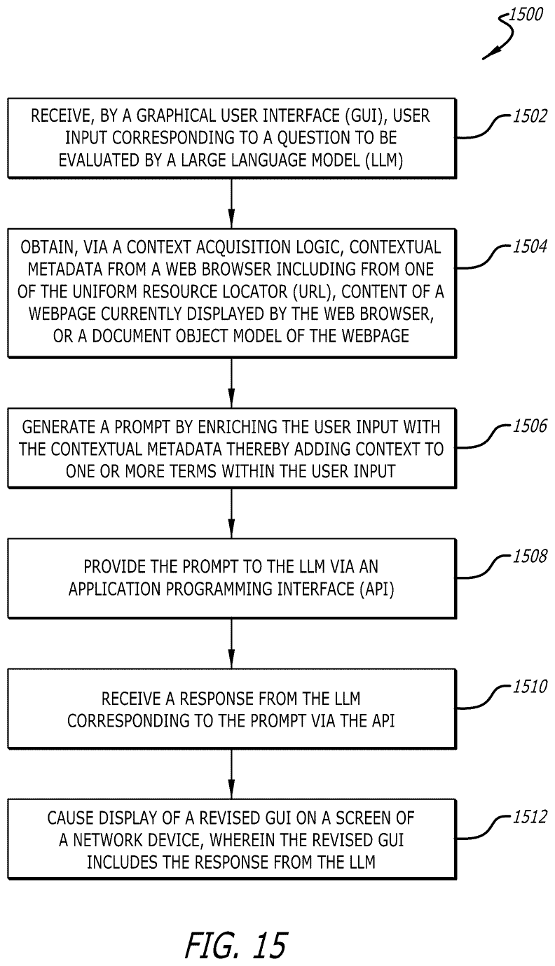

The non-transitory storage medium 1306 may include any non-transitory storage medium that contains the AI Assistant module 1308. The AI Assistant module 1308 may be a program, an application, or a software module that, when executed by the one or more processors 1302, causes the one or more processors 1302 to perform operations described in FIG. 14, FIG. 15, and FIG. 16. In one embodiment, the AI Assistant module 1308 includes an interface logic 1310, a context acquisition logic 1312, a prompt generation logic 1314, and an applications programming interface (API) data store 1316.

The interface logic 1310 may include hardware and software components to interface to several components in the network device 1300 and other devices connected to the network. The interface logic 1310 may interact with a graphical display unit, a graphical user interface (GUI), a media interface including audio and/or video and other input/output devices such as keyboard, mouse, trackball, etc. The interface logic 1310 may also interface with the LLM 1222 shown in FIG. 12, the APM, service plug-ins, observability tools, Web crawlers, Web browsers, network monitoring tools, website analysis tools, packet sniffers, Website scanners, LLM hallucination detection tools, and/or various APIs and databases.

The context acquisition logic 1312 may include logic, extraction, inference, or deduction to acquire, obtain, or generate a context associated with an object. It may interface with various tools via the interface logic 1310 to obtain assistance in the extraction or inference of contextual information from the object. The object may be any object related to the user's inquiry session with the LLM. Examples of objects that may have contextual information relevant to the user's inquiry may include a uniform resource locator (URL), a web page, or a document object model (DOM). The context acquisition logic 1312 will be described in more detail in FIG. 16.

The prompt generation logic 1314 generates the prompt or inquiry to be sent to the LLM. It combines the original user input and the context provided by the context acquisition logic 1312. In various embodiments, there may be different ways to combine these two items. The details will be described further in FIG. 15.

The API data store 1316 stores various types of data and information related to the LLM session. It may include public and private databases. It may include technical documents, datasheets, user's manuals, product descriptions, policy guidelines, and/or performance criteria. In various embodiments, the API data store 1316 may store data, information, or results provided by APIs involving in context generation or discovery. Knowledge, facts, and/or inference rules may be stored for use in a rule-based engine.

FIG. 14 is a flowchart illustrating example operations for performing a context acquisition process 1400 for a large language model prompt according to an implementation. The process 1400 begins with invoking a graphical user interface (GUI) to receive a user input corresponding to a question or an inquiry to be evaluated by a large language model (LLM) (block 1402). The process 1400 then proceeds to obtain contextual metadata from the user's web browser (block 1404). The task of determining the contextual metadata may be performed in one of several methods or a combination of a subset or all of these methods. These methods will be described further in FIG. 15 and FIG. 16.

Next, the process 1400 creates a composite inquiry by generating a prompt that includes the user input obtained in operation 1402 and the contextual metadata obtained in operation 1404 (block 1406). The combining of the user input and the contextual metadata will be described further in FIG. 15.

Then, the process 1400 provides the prompt or the composite inquiry to the LLM (block 1408). This may be accomplished by forwarding the combined text to the LLM via a text interface or an API. Upon receipt of the prompt, the LLM processes the inquiry and eventually generates a response. The process 1400 then receives the response from the LLM that corresponds to the prompt representing the composite inquiry (block 1410). The receipt of the response may take place via a text interface or API. Once the response from the LLM is received, the process 1400 causes a display of a revised GUI that includes the LLM response (block 1412). The details of the operation 1412 will be described in FIG. 15.

FIG. 15 is a flowchart illustrating example detailed operations for performing a context acquisition process 1500 for a large language model prompt according to an implementation. The process 1500 expands from the process 1400 with more details. The operations in the process 1500 may be similar to the corresponding operations in the process 1400.

The process 1500 begins with an operation 1502 which is similar to the operation 1402 in FIG. 14. The process 1500 begins with the receipt of a user input via a graphical user interface (GUI) (block 1502). The user input corresponds to a question or inquiry to be responded or evaluated by a large language model (LLM). The user input may be in any convenient form such as textual or audio and. Non-textual input may be converted to textual using appropriate tools. For example, speech-to-text converter or transcription tools may be used. Textual input may be formatted or edited to be free of irrelevant or non-essential elements such as punctuation marks, etc.

Next, the process 1500 obtains contextual metadata related to the user input via a context acquisition logic (block 1504). The contextual metadata may be obtained from a web browser including one of a URL, content of a webpage, or a document object model of the webpage. The webpage may be the page that is currently displayed by the web browser or one or more previous web pages visited by the user. For example, prior to starting an LLM inquiry session that invokes the AI Assistant, the user typically uses the web browser to navigate through various web pages. The history of navigation may reveal useful context for the inquiry such as the user's intent and/or interest. Each web page contains metadata that may be retrieved by several methods. One method examines the Hypertext Markup Language (HTML) source code and checks for tags that are related to metadata such as “title,” “description,” or “usage.” Another method invokes a meta tag checker tool through an appropriate interface such as the interface logic 1310 shown in FIG. 13. By following the user's navigation path, the process 1400 may obtain contextual information that may become relevant when coupled with the question. Other tools may also be exploited to discover relevant high-level information that may be used as context for a particular inquiry. The context acquisition logic will be described further in FIG. 16.

Once the contextual metadata items are obtained, the process 1500 creates a composite inquiry by generating a prompt (block 1506), the method for which may be is similar to operations of block 1406 in FIG. 14. Creating the composite inquiry by generating the prompt may be implemented by the prompt generation logic 1314 shown in FIG. 13, and serves to enrich the user input with the contextual metadata obtained in operations of block 1504. This may be accomplished by adding the context to one or more terms within the user input. For example, suppose the user enters the questions “Why is the success rate less than 100%” while on the web page of check-out service in the environment of apparel shopping, the composite inquiry may be created to read “Why is the success rate of the check-out service in the apparel shopping environment less than 100%?”

In various embodiments, the combining or merging of the user input and the contextual metadata may proceed in different methods. In one embodiment, the operation may be unconstrained. Any metadata discovered in operation 1504 may be used without limit. The advantages of this method are that the contextual information is rich and diversified, and the LLM will be free to discover relationships between them. The disadvantages are that the information may become overwhelming, causing divergence and the LLM may become confused for not being able to process the information coherently. In another embodiment, the operation may be selective or selectively constraint. Metadata may be selected or filtered according to some predefined criteria that are related to the original user's question. For example, geographical information about the user or the origin of the URL may be discarded. The advantages of this method include a smaller metadata size, high metadata quality, and efficient and focused LLM processing. The disadvantages include the difficulty of coming up with a workable set of criteria and the chance of missing important information. The choice of what method to use depends on the overall system objectives. In yet another embodiment, the process 1500 may include a machine learning mechanism (e.g., a small LLM, where the naming convention is related to a number of parameters considered) to select the appropriate method or the appropriate contextual metadata to be merged with the user input.

The creation of the composite inquiry may include a reformatting or conversion of the original user input into a more appropriate form or substance. The task may include checking for clarity and specificity in terminologies or expressions. For example, the original user input uses the term “failure” or “error rate” but the contextual metadata contain mostly information related to “success” or “achievement.” It is therefore more consistent by converting the term “error rate” in the original user input to “success rate” and convert the corresponding parameters (e.g., a failure rate of 15% is equivalent to a success rate of 85%). In addition, the conversion may also focus on the substance of the inquiry. For example, the original user input may be in the form of a question (e.g., “Why is the success rate less than 100%?”) without any context, but the prompt or the composite inquiry may be in the form of an instruction with context (e.g., “Based on the service category of check-out and the environment of apparel shopping, explain the success rate of 97%”). This may be performed by a pre-processing module that screens the contextual metadata and the original user input to determine the relationship or connections between them. This task is typically done when the size of the contextual metadata is small.

After the prompt is created, the process 1500 provides the prompt to the LLM (block 1508), the operation of which may be similar to that of block 1408 in FIG. 14. This operation may be accomplished by an appropriate task including forwarding the combined text to the LLM via a text interface or an API. Upon receipt of the prompt, the LLM processes the inquiry and eventually generates a response. The process 1500 then receives the response from the LLM that corresponds to the prompt representing the composite inquiry (block 1510). The receipt of the response may take place via a text interface or API.

Once the response from the LLM is received, the process 1500 causes a display of a revised GUI that includes the LLM response (block 1512). The revised GUI may be displayed on a screen of a network device (e.g., the network device 1300 in FIG. 13). The process 1500 may optionally include checking the LLM response for consistency and obvious problematic issues. In addition, when the LLM provides a confidence score for its own response, this confidence score may be used to evaluate the LLM response. In some rare cases, often referred to as “hallucinations,” the LLM may provide a totally incorrect response which may have little to do with the inquiry or the context. The check for hallucination may be done by verification with established knowledge, evaluating semantic coherence between the response and the inquiry, determining if there is contradiction between the response and the inquiry, or employing hallucination detection tool via the interface logic 1310 shown in FIG. 13. The operation of block 1512 may format the response in the form appropriate for display by updating the display area provided by the GUI. The process 1500 is then ended.

FIG. 16 is a diagram illustrating a context acquisition logic 1312 shown in FIG. 13 according to an implementation. The context acquisition logic 1312 includes an application performance monitoring (APM) tool 1610, a context extractor 1620, an observability tool 1630, and a context provider 1640. The context acquisition logic 1312 may include more or less than the above components.

The APM tool 1610 may be an application, or a software module configured to monitor and analyze the performance of other APIs or applications. It may provide a wide range of metrics, including response times, latency, throughput, error rates, resource usage, detailed error analysis, root cause identification, performance profiling, and others. The APM tool 1610 interacts with the context extractor 1620 and the context provider 1640 to supply contextual information related to performance or other system issues.

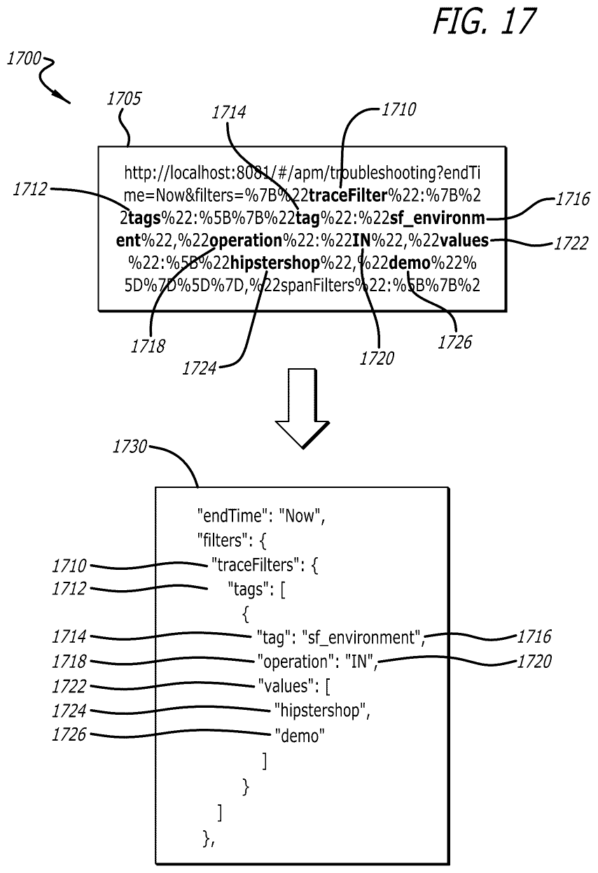

The context extractor 1620 is configured to extract contextual information from at least one of N objects 1625; (i=1, . . . , N). The object 1625; may be any object that may have contextual information related to the user input or inquiry. Examples of the object 1625; include a URL, an email, a web page, or a document object model (DOM) (e.g., a screenshot of a web page). The extraction from a URL may include scanning the URL and identifying metadata elements in the URL string. The extraction from a web page may be performed by fetching the HTML content of a webpage, extracting the desired information using web scraping tools, parsing the document to identify elements such as paragraphs, headings, and images. Techniques in image recognition may be employed to analyze images or visual elements. An example to illustrate the extraction of metadata from an URL is given in FIG. 17.

Navigation history of the user may be useful for contextual information. The nature of the visited web pages may provide a clue on the user's intent or interests. This may be useful to infer user's preferences. For example, suppose a user inquiry is “Show me EC2 instances with a high CPU utilization.” EC2 is Elastic Compute Cloud. An EC2 instance is a virtual server in the Amazon Cloud. The inquiry may be ambiguous because it is unclear whether the user wants to see the infrastructure that shows the EC2 instances or whether the user wants to start a computation that calculates the average CPU utilization. There are two tools that can respond to the user's inquiry. If the user is interested in the infrastructure, an infrastructure tool would be appropriate. On the other hand, if the user is interested in computational metrics, a signal flow tool may be more appropriate. An examination of the navigation history may reveal the user's intent or interest and that contextual information, when merged with the inquiry, can provide a useful clue for the LLM to generate a response. In the above example, suppose the navigation history shows most of the web pages the user visits are about computational metrics. The context extractor 1620 may then extract the computational metric context and forward to the content provider 1640 to compose a composite inquiry to send to the prompt generation logic 1314.

The observability tool 1630 may be an application, a program, or a software module that is configured to collect, analyze, and visualize data in a network environment. As mentioned earlier in the description of FIG. 11, the chatbot used with the AI Assistant 1308 typically incorporates an observability tool that may be used as the observability tool 1630. The observability tool 1630 may produce results from correlating insights, user behavior analytics, and integration other tools. As an example, the observability tool 1630 may identify user intents and preferences which may be helpful in forming contexts for the user inquiry. Various embodiments may also use the observability tool 1630 to obtain telemetry data including metrics, logs, and traces. The observability tool 1630 may store its findings or results in a cache 1635. The cache 1635 may be a storage allocated for storing data produced by the observability tool 1630. The context extractor 1620 accesses the cache 1635 to retrieve the observability data to incorporate into the extracted information.

The context provider 1640 integrates the information from the APM tool 1610, the context extractor 1620, and the observability tool 1630 to generate contextual information to be appended to the user input in the creation of the prompt or composite inquiry by the prompt generation logic 1314. The context provider 1640 may employ a set of rules to select the contextual information including resolving any contradictory data.

Since the number of contexts provided by the APM tool 1610, the context extractor 1620, and the observability tool 1630 may be numerous and their significance may be different depending on the user input or question, it may be useful to be selective in using the contexts. However, it is usually not known in advance the weights or significance of the contexts. Therefore, it may be useful to perform the selection iteratively. Initially, all the contexts are stored in a context store. These contexts may include all the contexts such as the user's intent, the user's interests, the error rates of all the service types, etc. This iterative process may start with a subset of contexts that is ranked to be highly relevant. Then the composite inquiry is created and sent to the LLM. When the LLM response is received, the AI Assistant evaluates the response including the confidence score provided by the LLM and other data regarding the usefulness of the current contextual information. If these data indicate the LLM response is satisfactory or all the contexts have been used, the process is stopped and the LLM response is presented to the user as the final response. If these data indicate the LLM response is not satisfactory such as the confidence score is below a predefined threshold or the LLM response explicitly questions the validity of the contexts, the AI Assistant retrieves an additional subset of contexts from the context store and the process is repeated. This iterative process may be modified using various schemes. For example, the above example starts with the most relevant context subset. Another scheme is to start with the least relevant context subset. Another scheme is to divide the contexts into different categories (e.g., URL related, web page related, APM related) and try each category in each iteration.

FIG. 17 is a diagram illustrating an example 1700 of extracting contextual metadata from a URL according to an implementation. The example 1700 includes a URL string 1705 and a code 1730. A typical URL string includes 10 parts: the scheme, subdomain, top-level domain, second-level domain, subdirectory, parameter, port, path, query, and fragment. The URL string 1705 is a partial URL string. It has the scheme or protocol https://, a subdomain localhost, a set of % 22 as the URL-encode for quotation mark, and a set of parameters or substrings. The parameters in the URL string 1705 include parameters 1710, 1712, 1714, 1716, 1718, 1720, 1722, 1724, and 1726 that correspond, respectively, to substrings to “tracefilter,” “tags,” “tag,” “sf_environment,” “operation,” “IN,” “values,” “hipstershop,” and “demo.”

The extracting of the URL string 1705 scans the string 1705, identifies the URL-encode symbol % 22, and extracts the substring enclosed by the symbols % 22. The process organizes and formats the extracted substrings in the code 1730. The code shows the parameters 1710, 1712, 1714, 1716, 1718, 1720, 1722, 1724, and 1726 in the appropriate format. The extracted metadata may then be examined together with other parameters or information to construct a meaningful context for the user inquiry.

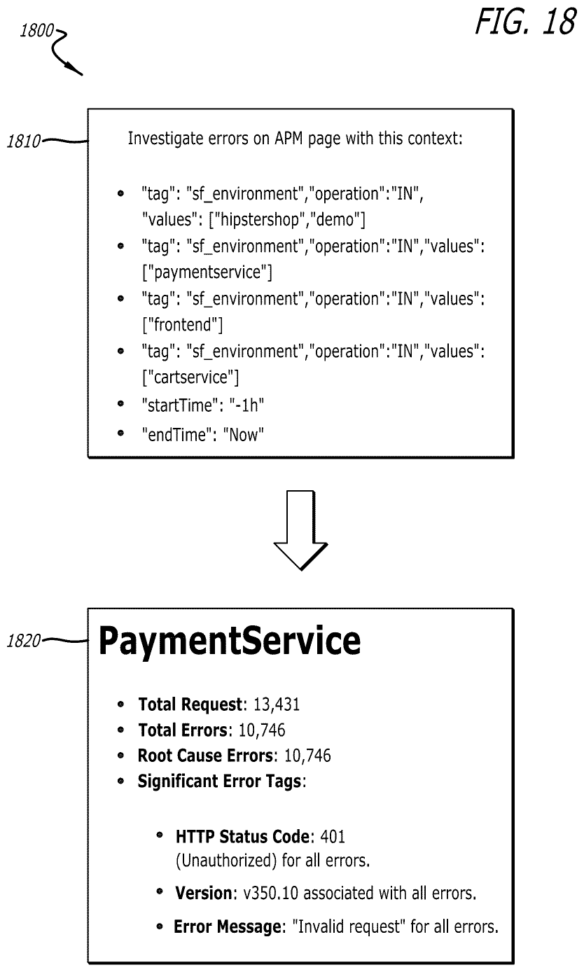

FIG. 18 is a diagram illustrating an example 1800 of contextual information based on the metadata obtained from the example in FIG. 17 according to an implementation. The example 1800 includes an instruction 1810 and a result 1820. The instruction 1810 instructs an error detection application to investigate errors on the APM page with the context obtained from the URL string 1705 shown in FIG. 17. The parameters extracted from the URL string 1705 includes a tag “sf_environment” with the operation IN “paymentservice.” The result 1820 returns the findings of a total number of errors of 10,746 out of a total number of requests of 13,431. The error tags show the “Unauthorized” error code.

This example illustrates that the metadata extracted from a URL string may be used to identify sources of errors which may be part of the user inquiry. The errors discovered at the payment service may be used as context for the user inquiry regarding the statistics of the success rate. This example shows that by just examining the URL string of the user's current web page, the AI Assistant is able to obtain the context related to the user input or inquiry.

The AI Assistant in this disclosure provides several technical advantages over existing techniques. These advantages include, but are not limited to, the following.

1. Provide seamless and efficient user experience in an inquiry-response session with an LLM. The contextual information is extracted without a user's request or intervention. In most cases, the user does not even know his or her question is being supplemented by the context. The context extractor 1620 automatically extracts the contextual metadata and formulates the contextual information based on objects that are already in existence without the user's knowledge. These objects include at least the URL string 1705 and the web page the user is currently on.
2. The contextual information is rich, comprehensive, and diversified. The context acquisition logic 1312 includes several sources of information that may be exploited to provide relevant contexts related to the user inquiry. These sources include the APM tool 1610, the objects 16251 to 1625N, and the observability tool 1630. These sources represent a wide range of information, from the user URL and web pages to the user behavior and intent. The comprehensive and diversified characteristics of the contextual information guide the LLM to discover relevant data that can be utilized to shape the response to be tailored made to the user inquiry.
3. The contextual information helps clarify the user inquiry and resolves any ambiguity in the inquiry. By exploiting user's intent, preferences, or behaviors, the AI Assistant is able to determine unintentionally hidden aspects in the user inquiry to allow the LLM to deliver intelligent responses that are tailored to the user's needs.
4. The overall system employs existing resources and therefore requires minimal additional computing resources. The AI Assistant uses existing applications or tools without additional investment in developing capabilities. For example, the chatbot, the GUI, the APM tool 1610 and the observability tool 1630 are available.
5. The AI Assistant helps protect the system from attacks and increases system's security. The AI Assistant composes the composite inquiry by incorporating contextual information into the user inquiry before sending it to the LLM. Therefore, attacks like prompt injections are very difficult because it is not possible to compromise the elements individually when there is inherent coherence between the user inquiry, the inquiry's context, and the user's intent and behavior.

Other advantages include: (1) scalability because there are no restrictions on adding tools or applications, (2) fault tolerance because there is a variety of sources that provide different types of context, and (3) wide applications because the AI Assistant has no requirements for specific applications.

Entities that operate computing environments need information about their computing environments. For example, an entity may need to know the operating status of the various computing resources in the entity's computing environment, so that the entity can administer the environment, including performing configuration and maintenance, performing repairs or replacements, provisioning additional resources, removing unused resources, or addressing issues that may arise during operation of the computing environment, among other examples. As another example, an entity can use information about a computing environment to identify and remediate security issues that may endanger the data, users, and/or equipment in the computing environment. As another example, an entity may be operating a computing environment for some purpose (e.g., to run an online store, to operate a bank, to manage a municipal railway, etc.) and may want information about the computing environment that can aid the entity in understanding whether the computing environment is operating efficiently and for its intended purpose.

Collection and analysis of the data from a computing environment can be performed by a data intake and query system such as is described herein. A data intake and query system can ingest and store data obtained from the components in a computing environment, and can enable an entity to search, analyze, and visualize the data. Through these and other capabilities, the data intake and query system can enable an entity to use the data for administration of the computing environment, to detect security issues, to understand how the computing environment is performing or being used, and/or to perform other analytics.

FIG. 19 is a block diagram illustrating an example computing environment 1900 that includes a data intake and query system 1910. The data intake and query system 1910 obtains data from a data source 1902 in the computing environment 1900 and ingests the data using an indexing system 1920. A search system 1960 of the data intake and query system 1910 enables users to navigate the indexed data. Though drawn with separate boxes in FIG. 19, in some implementations the indexing system 1920 and the search system 1960 can have overlapping components. A computing device 1904, running a network access application 1906, can communicate with the data intake and query system 1910 through a user interface system 1914 of the data intake and query system 1910. Using the computing device 1904, a user can perform various operations with respect to the data intake and query system 1910, such as administration of the data intake and query system 1910, management and generation of “knowledge objects,” (user-defined entities for enriching data, such as saved searches, event types, tags, field extractions, lookups, reports, alerts, data models, workflow actions, and fields), initiating of searches, and generation of reports, among other operations. The data intake and query system 1910 can further optionally include apps 1912 that extend the search, analytics, and/or visualization capabilities of the data intake and query system 1910.

The data intake and query system 1910 can be implemented using program code that can be executed using a computing device. A computing device is an electronic device that has a memory for storing program code instructions and a hardware processor for executing the instructions. The computing device can further include other physical components, such as a network interface or components for input and output. The program code for the data intake and query system 1910 can be stored on a non-transitory computer-readable medium, such as a magnetic or optical storage disk or a flash or solid-state memory, from which the program code can be loaded into the memory of the computing device for execution. “Non-transitory” means that the computer-readable medium can retain the program code while not under power, as opposed to volatile or “transitory” memory or media that requires power in order to retain data.

In various examples, the program code for the data intake and query system 1910 can be executed on a single computing device, or execution of the program code can be distributed over multiple computing devices. For example, the program code can include instructions for both indexing and search components (which may be part of the indexing system 1920 and/or the search system 1960, respectively), which can be executed on a computing device that also provides the data source 1902. As another example, the program code can be executed on one computing device, where execution of the program code provides both indexing and search components, while another copy of the program code executes on a second computing device that provides the data source 1902. As another example, the program code can be configured such that, when executed, the program code implements only an indexing component or only a search component. In this example, a first instance of the program code that is executing the indexing component and a second instance of the program code that is executing the search component can be executing on the same computing device or on different computing devices.

The data source 1902 of the computing environment 1900 is a component of a computing device that produces machine data. The component can be a hardware component (e.g., a microprocessor or a network adapter, among other examples) or a software component (e.g., a part of the operating system or an application, among other examples). The component can be a virtual component, such as a virtual machine, a virtual machine monitor (also referred as a hypervisor), a container, or a container orchestrator, among other examples. Examples of computing devices that can provide the data source 1902 include personal computers (e.g., laptops, desktop computers, etc.), handheld devices (e.g., smart phones, tablet computers, etc.), servers (e.g., network servers, compute servers, storage servers, domain name servers, web servers, etc.), network infrastructure devices (e.g., routers, switches, firewalls, etc.), and “Internet of Things” devices (e.g., vehicles, home appliances, factory equipment, etc.), among other examples. Machine data is electronically generated data that is output by the component of the computing device and reflects activity of the component. Such activity can include, for example, operation status, actions performed, performance metrics, communications with other components, or communications with users, among other examples. The component can produce machine data in an automated fashion (e.g., through the ordinary course of being powered on and/or executing) and/or as a result of user interaction with the computing device (e.g., through the user's use of input/output devices or applications). The machine data can be structured, semi-structured, and/or unstructured. The machine data may be referred to as raw machine data when the data is unaltered from the format in which the data was output by the component of the computing device. Examples of machine data include operating system logs, web server logs, live application logs, network feeds, metrics, change monitoring, message queues, and archive files, among other examples.

As discussed in greater detail below, the indexing system 1920 obtains machine date from the data source 1902 and processes and stores the data. Processing and storing of data may be referred to as “ingestion” of the data. Processing of the data can include parsing the data to identify individual events, where an event is a discrete portion of machine data that can be associated with a timestamp. Processing of the data can further include generating an index of the events, where the index is a data storage structure in which the events are stored. The indexing system 1920 does not require prior knowledge of the structure of incoming data (e.g., the indexing system 1920 does not need to be provided with a schema describing the data). Additionally, the indexing system 1920 retains a copy of the data as it was received by the indexing system 1920 such that the original data is always available for searching (e.g., no data is discarded, though, in some examples, the indexing system 1920 can be configured to do so).

The search system 1960 searches the data stored by the indexing 1920 system. As discussed in greater detail below, the search system 1960 enables users associated with the computing environment 1900 (and possibly also other users) to navigate the data, generate reports, and visualize search results in “dashboards” output using a graphical interface. Using the facilities of the search system 1960, users can obtain insights about the data, such as retrieving events from an index, calculating metrics, searching for specific conditions within a rolling time window, identifying patterns in the data, and predicting future trends, among other examples. To achieve greater efficiency, the search system 1960 can apply map-reduce methods to parallelize searching of large volumes of data. Additionally, because the original data is available, the search system 1960 can apply a schema to the data at search time. This allows different structures to be applied to the same data, or for the structure to be modified if or when the content of the data changes. Application of a schema at search time may be referred to herein as a late-binding schema technique.

The user interface system 1914 provides mechanisms through which users associated with the computing environment 1900 (and possibly others) can interact with the data intake and query system 1910. These interactions can include configuration, administration, and management of the indexing system 1920, initiation and/or scheduling of queries that are to be processed by the search system 1960, receipt or reporting of search results, and/or visualization of search results. The user interface system 1914 can include, for example, facilities to provide a command line interface or a web-based interface.

Users can access the user interface system 1914 using a computing device 1904 that communicates with data intake and query system 1910, possibly over a network. A “user,” in the context of the implementations and examples described herein, is a digital entity that is described by a set of information in a computing environment. The set of information can include, for example, a user identifier, a username, a password, a user account, a set of authentication credentials, a token, other data, and/or a combination of the preceding. Using the digital entity that is represented by a user, a person can interact with the computing environment 1900. For example, a person can log in as a particular user and, using the user's digital information, can access the data intake and query system 1910. A user can be associated with one or more people, meaning that one or more people may be able to use the same user's digital information. For example, an administrative user account may be used by multiple people who have been given access to the administrative user account. Alternatively or additionally, a user can be associated with another digital entity, such as a bot (e.g., a software program that can perform autonomous tasks). A user can also be associated with one or more entities. For example, a company can have associated with it a number of users. In this example, the company may control the users' digital information, including assignment of user identifiers, management of security credentials, control of which persons are associated with which users, and so on.

The computing device 1904 can provide a human-machine interface through which a person can have a digital presence in the computing environment 1900 in the form of a user. The computing device 1904 is an electronic device having one or more processors and a memory capable of storing instructions for execution by the one or more processors. The computing device 1904 can further include input/output (I/O) hardware and a network interface. Applications executed by the computing device 1904 can include a network access application 1906, such as a web browser, which can use a network interface of the client computing device 1904 to communicate, over a network, with the user interface system 1914 of the data intake and query system 1910. The user interface system 1914 can use the network access application 1906 to generate user interfaces that enable a user to interact with the data intake and query system 1910. A web browser is one example of a network access application. A shell tool can also be used as a network access application. In some examples, the data intake and query system 1910 is an application executing on the computing device 1906. In such examples, the network access application 1906 can access the user interface system 1914 without going over a network.

The data intake and query system 1910 can optionally include apps 1912. An app of the data intake and query system 1910 is a collection of configurations, knowledge objects (a user-defined entity that enriches the data in the data intake and query system 1910), views, and dashboards that may provide additional functionality, different techniques for searching the data, and/or additional insights into the data. The data intake and query system 1910 can execute multiple applications simultaneously. Example applications include an information technology service intelligence application, which can monitor and analyze the performance and behavior of the computing environment 1900, and an enterprise security application, which can include content and searches to assist security analysts in diagnosing and acting on anomalous or malicious behavior in the computing environment 1900.

Though FIG. 19 illustrates only one data source, in practical implementations, the computing environment 1900 contains many data sources spread across numerous computing devices. The computing devices may be controlled and operated by a single entity. For example, in an “on the premises” or “on-prem” implementation, the computing devices may physically and digitally be controlled by one entity, meaning that the computing devices are in physical locations that are owned and/or operated by the entity and are within a network domain that is controlled by the entity. In an entirely on-prem implementation of the computing environment 1900, the data intake and query system 1910 executes on an on-prem computing device and obtains machine data from on-prem data sources. An on-prem implementation can also be referred to as an “enterprise” network, though the term “on-prem” refers primarily to physical locality of a network and who controls that location while the term “enterprise” may be used to refer to the network of a single entity. As such, an enterprise network could include cloud components.

“Cloud” or “in the cloud” refers to a network model in which an entity operates network resources (e.g., processor capacity, network capacity, storage capacity, etc.), located for example in a data center, and makes those resources available to users and/or other entities over a network. A “private cloud” is a cloud implementation where the entity provides the network resources only to its own users. A “public cloud” is a cloud implementation where an entity operates network resources in order to provide them to users that are not associated with the entity and/or to other entities. In this implementation, the provider entity can, for example, allow a subscriber entity to pay for a subscription that enables users associated with subscriber entity to access a certain amount of the provider entity's cloud resources, possibly for a limited time. A subscriber entity of cloud resources can also be referred to as a tenant of the provider entity. Users associated with the subscriber entity access the cloud resources over a network, which may include the public Internet. In contrast to an on-prem implementation, a subscriber entity does not have physical control of the computing devices that are in the cloud, and has digital access to resources provided by the computing devices only to the extent that such access is enabled by the provider entity.

In some implementations, the computing environment 1900 can include on-prem and cloud-based computing resources, or only cloud-based resources. For example, an entity may have on-prem computing devices and a private cloud. In this example, the entity operates the data intake and query system 1910 and can choose to execute the data intake and query system 1910 on an on-prem computing device or in the cloud. In another example, a provider entity operates the data intake and query system 1910 in a public cloud and provides the functionality of the data intake and query system 1910 as a service, for example under a Software-as-a-Service (SaaS) model, to entities that pay for the user of the service on a subscription basis. In this example, the provider entity can provision a separate tenant (or possibly multiple tenants) in the public cloud network for each subscriber entity, where each tenant executes a separate and distinct instance of the data intake and query system 1910. In some implementations, the entity providing the data intake and query system 1910 is itself subscribing to the cloud services of a cloud service provider. As an example, a first entity provides computing resources under a public cloud service model, a second entity subscribes to the cloud services of the first provider entity and uses the cloud computing resources to operate the data intake and query system 1910, and a third entity can subscribe to the services of the second provider entity in order to use the functionality of the data intake and query system 1910. In this example, the data sources are associated with the third entity, users accessing the data intake and query system 1910 are associated with the third entity, and the analytics and insights provided by the data intake and query system 1910 are for purposes of the third entity's operations.

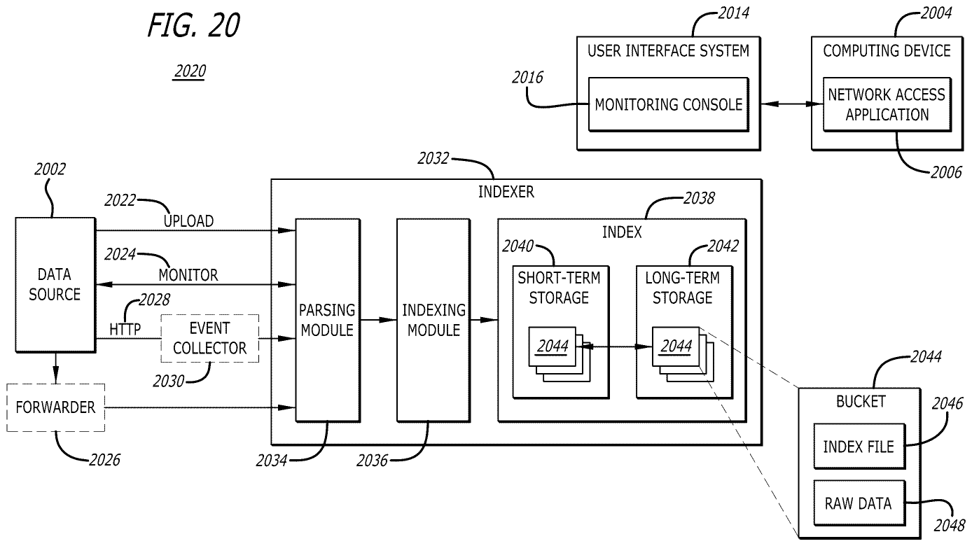

FIG. 20 is a block diagram illustrating in greater detail an example of an indexing system 2020 of a data intake and query system, such as the data intake and query system 1910 of FIG. 19. The indexing system 2020 of FIG. 20 uses various methods to obtain machine data from a data source 2002 and stores the data in an index 2038 of an indexer 2032. As discussed previously, a data source is a hardware, software, physical, and/or virtual component of a computing device that produces machine data in an automated fashion and/or as a result of user interaction. Examples of data sources include files and directories; network event logs; operating system logs, operational data, and performance monitoring data; metrics; first-in, first-out queues; scripted inputs; and modular inputs, among others. The indexing system 2020 enables the data intake and query system to obtain the machine data produced by the data source 2002 and to store the data for searching and retrieval.

Users can administer the operations of the indexing system 2020 using a computing device 2004 that can access the indexing system 2020 through a user interface system 2014 of the data intake and query system. For example, the computing device 2004 can be executing a network access application 2006, such as a web browser or a terminal, through which a user can access a monitoring console 2016 provided by the user interface system 2014. The monitoring console 2016 can enable operations such as: identifying the data source 2002 for data ingestion; configuring the indexer 2032 to index the data from the data source 2032; configuring a data ingestion method; configuring, deploying, and managing clusters of indexers; and viewing the topology and performance of a deployment of the data intake and query system, among other operations. The operations performed by the indexing system 2020 may be referred to as “index time” operations, which are distinct from “search time” operations that are discussed further below.

The indexer 2032, which may be referred to herein as a data indexing component, coordinates and performs most of the index time operations. The indexer 2032 can be implemented using program code that can be executed on a computing device. The program code for the indexer 2032 can be stored on a non-transitory computer-readable medium (e.g. a magnetic, optical, or solid state storage disk, a flash memory, or another type of non-transitory storage media), and from this medium can be loaded or copied to the memory of the computing device. One or more hardware processors of the computing device can read the program code from the memory and execute the program code in order to implement the operations of the indexer 2032. In some implementations, the indexer 2032 executes on the computing device 2004 through which a user can access the indexing system 2020. In some implementations, the indexer 2032 executes on a different computing device than the illustrated computing device 2004.

The indexer 2032 may be executing on the computing device that also provides the data source 2002 or may be executing on a different computing device. In implementations wherein the indexer 2032 is on the same computing device as the data source 2002, the data produced by the data source 2002 may be referred to as “local data.” In other implementations the data source 2002 is a component of a first computing device and the indexer 2032 executes on a second computing device that is different from the first computing device. In these implementations, the data produced by the data source 2002 may be referred to as “remote data.” In some implementations, the first computing device is “on-prem” and in some implementations the first computing device is “in the cloud.” In some implementations, the indexer 2032 executes on a computing device in the cloud and the operations of the indexer 2032 are provided as a service to entities that subscribe to the services provided by the data intake and query system.

For a given data produced by the data source 2002, the indexing system 2020 can be configured to use one of several methods to ingest the data into the indexer 2032. These methods include upload 2022, monitor 2024, using a forwarder 2026, or using HyperText Transfer Protocol (HTTP 2028) and an event collector 2030. These and other methods for data ingestion may be referred to as “getting data in” (GDI) methods.

Using the upload 2022 method, a user can specify a file for uploading into the indexer 2032. For example, the monitoring console 2016 can include commands or an interface through which the user can specify where the file is located (e.g., on which computing device and/or in which directory of a file system) and the name of the file. The file may be located at the data source 2002 or maybe on the computing device where the indexer 2032 is executing. Once uploading is initiated, the indexer 2032 processes the file, as discussed further below. Uploading is a manual process and occurs when instigated by a user. For automated data ingestion, the other ingestion methods are used.

The monitor 2024 method enables the indexing system 2002 to monitor the data source 2002 and continuously or periodically obtain data produced by the data source 2002 for ingestion by the indexer 2032. For example, using the monitoring console 2016, a user can specify a file or directory for monitoring. In this example, the indexing system 2002 can execute a monitoring process that detects whenever the file or directory is modified and causes the file or directory contents to be sent to the indexer 2032. As another example, a user can specify a network port for monitoring. In this example, a monitoring process can capture data received at or transmitting from the network port and cause the data to be sent to the indexer 2032. In various examples, monitoring can also be configured for data sources such as operating system event logs, performance data generated by an operating system, operating system registries, operating system directory services, and other data sources.

Monitoring is available when the data source 2002 is local to the indexer 2032 (e.g., the data source 2002 is on the computing device where the indexer 2032 is executing). Other data ingestion methods, including forwarding and the event collector 2030, can be used for either local or remote data sources.

A forwarder 2026, which may be referred to herein as a data forwarding component, is a software process that sends data from the data source 2002 to the indexer 2032. The forwarder 2026 can be implemented using program code that can be executed on the computer device that provides the data source 2002. A user launches the program code for the forwarder 2026 on the computing device that provides the data source 2002. The user can further configure the forwarder 2026, for example to specify a receiver for the data being forwarded (e.g., one or more indexers, another forwarder, and/or another recipient system), to enable or disable data forwarding, and to specify a file, directory, network events, operating system data, or other data to forward, among other operations.

The forwarder 2026 can provide various capabilities. For example, the forwarder 2026 can send the data unprocessed or can perform minimal processing on the data before sending the data to the indexer 2032. Minimal processing can include, for example, adding metadata tags to the data to identify a source, source type, and/or host, among other information, dividing the data into blocks, and/or applying a timestamp to the data. In some implementations, the forwarder 2026 can break the data into individual events (event generation is discussed further below) and send the events to a receiver. Other operations that the forwarder 2026 may be configured to perform include buffering data, compressing data, and using secure protocols for sending the data, for example.

Forwarders can be configured in various topologies. For example, multiple forwarders can send data to the same indexer. As another example, a forwarder can be configured to filter and/or route events to specific receivers (e.g., different indexers), and/or discard events. As another example, a forwarder can be configured to send data to another forwarder, or to a receiver that is not an indexer or a forwarder (such as, for example, a log aggregator).

The event collector 2030 provides an alternate method for obtaining data from the data source 2002. The event collector 2030 enables data and application events to be sent to the indexer 2032 using HTTP 2028. The event collector 2030 can be implemented using program code that can be executing on a computing device. The program code may be a component of the data intake and query system or can be a standalone component that can be executed independently of the data intake and query system and operates in cooperation with the data intake and query system.

To use the event collector 2030, a user can, for example using the monitoring console 2016 or a similar interface provided by the user interface system 2014, enable the event collector 2030 and configure an authentication token. In this context, an authentication token is a piece of digital data generated by a computing device, such as a server, that contains information to identify a particular entity, such as a user or a computing device, to the server. The token will contain identification information for the entity (e.g., an alphanumeric string that is unique to each token) and a code that authenticates the entity with the server. The token can be used, for example, by the data source 2002 as an alternative method to using a username and password for authentication.

To send data to the event collector 2030, the data source 2002 is supplied with a token and can then send HTTP 2028 requests to the event collector 2030. To send HTTP 2028 requests, the data source 2002 can be configured to use an HTTP client and/or to use logging libraries such as those supplied by Java, JavaScript, and .NET libraries. An HTTP client enables the data source 2002 to send data to the event collector 2030 by supplying the data, and a Uniform Resource Identifier (URI) for the event collector 2030 to the HTTP client. The HTTP client then handles establishing a connection with the event collector 2030, transmitting a request containing the data, closing the connection, and receiving an acknowledgment if the event collector 2030 sends one. Logging libraries enable HTTP 2028 requests to the event collector 2030 to be generated directly by the data source. For example, an application can include or link a logging library, and through functionality provided by the logging library manage establishing a connection with the event collector 2030, transmitting a request, and receiving an acknowledgement.

An HTTP 2028 request to the event collector 2030 can contain a token, a channel identifier, event metadata, and/or event data. The token authenticates the request with the event collector 2030. The channel identifier, if available in the indexing system 2020, enables the event collector 2030 to segregate and keep separate data from different data sources. The event metadata can include one or more key-value pairs that describe the data source 2002 or the event data included in the request. For example, the event metadata can include key-value pairs specifying a timestamp, a hostname, a source, a source type, or an index where the event data should be indexed. The event data can be a structured data object, such as a JavaScript Object Notation (JSON) object, or raw text. The structured data object can include both event data and event metadata. Additionally, one request can include event data for one or more events.

In some implementations, the event collector 2030 extracts events from HTTP 2028 requests and sends the events to the indexer 2032. The event collector 2030 can further be configured to send events to one or more indexers. Extracting the events can include associating any metadata in a request with the event or events included in the request. In these implementations, event generation by the indexer 2032 (discussed further below) is bypassed, and the indexer 2032 moves the events directly to indexing. In some implementations, the event collector 2030 extracts event data from a request and outputs the event data to the indexer 2032, and the indexer generates events from the event data. In some implementations, the event collector 2030 sends an acknowledgement message to the data source 2002 to indicate that the event collector 2030 has received a particular request form the data source 2002, and/or to indicate to the data source 2002 that events in the request have been added to an index.

The indexer 2032 ingests incoming data and transforms the data into searchable knowledge in the form of events. In the data intake and query system, an event is a single piece of data that represents activity of the component represented in FIG. 20 by the data source 2002. An event can be, for example, a single record in a log file that records a single action performed by the component (e.g., a user login, a disk read, transmission of a network packet, etc.). An event includes one or more fields that together describe the action captured by the event, where a field is a key-value pair (also referred to as a name-value pair). In some cases, an event includes both the key and the value, and in some cases the event includes only the value and the key can be inferred or assumed.

Transformation of data into events can include event generation and event indexing. Event generation includes identifying each discrete piece of data that represents one event and associating each event with a timestamp and possibly other information (which may be referred to herein as metadata). Event indexing includes storing of each event in the data structure of an index. As an example, the indexer 2032 can include a parsing module 2034 and an indexing module 2036 for generating and storing the events. The parsing module 2034 and indexing module 2036 can be modular and pipelined, such that one component can be operating on a first set of data while the second component is simultaneously operating on a second sent of data. Additionally, the indexer 2032 may at any time have multiple instances of the parsing module 2034 and indexing module 2036, with each set of instances configured to simultaneously operate on data from the same data source or from different data sources. The parsing module 2034 and indexing module 2036 are illustrated in FIG. 20 to facilitate discussion, with the understanding that implementations with other components are possible to achieve the same functionality.

The parsing module 2034 determines information about incoming event data, where the information can be used to identify events within the event data. For example, the parsing module 2034 can associate a source type with the event data. A source type identifies the data source 2002 and describes a possible data structure of event data produced by the data source 2002. For example, the source type can indicate which fields to expect in events generated at the data source 2002 and the keys for the values in the fields, and possibly other information such as sizes of fields, an order of the fields, a field separator, and so on. The source type of the data source 2002 can be specified when the data source 2002 is configured as a source of event data. Alternatively, the parsing module 2034 can determine the source type from the event data, for example from an event field in the event data or using machine learning techniques applied to the event data.

Other information that the parsing module 2034 can determine includes timestamps. In some cases, an event includes a timestamp as a field, and the timestamp indicates a point in time when the action represented by the event occurred or was recorded by the data source 2002 as event data. In these cases, the parsing module 2034 may be able to determine from the source type associated with the event data that the timestamps can be extracted from the events themselves. In some cases, an event does not include a timestamp and the parsing module 2034 determines a timestamp for the event, for example from a name associated with the event data from the data source 2002 (e.g., a file name when the event data is in the form of a file) or a time associated with the event data (e.g., a file modification time). As another example, when the parsing module 2034 is not able to determine a timestamp from the event data, the parsing module 2034 may use the time at which it is indexing the event data. As another example, the parsing module 2034 can use a user-configured rule to determine the timestamps to associate with events.

The parsing module 2034 can further determine event boundaries. In some cases, a single line (e.g., a sequence of characters ending with a line termination) in event data represents one event while in other cases, a single line represents multiple events. In yet other cases, one event may span multiple lines within the event data. The parsing module 2034 may be able to determine event boundaries from the source type associated with the event data, for example from a data structure indicated by the source type. In some implementations, a user can configure rules the parsing module 2034 can use to identify event boundaries.

The parsing module 2034 can further extract data from events and possibly also perform transformations on the events. For example, the parsing module 2034 can extract a set of fields (key-value pairs) for each event, such as a host or hostname, source or source name, and/or source type. The parsing module 2034 may extract certain fields by default or based on a user configuration. Alternatively or additionally, the parsing module 2034 may add fields to events, such as a source type or a user-configured field. As another example of a transformation, the parsing module 2034 can anonymize fields in events to mask sensitive information, such as social security numbers or account numbers. Anonymizing fields can include changing or replacing values of specific fields. The parsing component 2034 can further perform user-configured transformations.

The parsing module 2034 outputs the results of processing incoming event data to the indexing module 2036, which performs event segmentation and builds index data structures.

Event segmentation identifies searchable segments, which may alternatively be referred to as searchable terms or keywords, which can be used by the search system of the data intake and query system to search the event data. A searchable segment may be a part of a field in an event or an entire field. The indexer 2032 can be configured to identify searchable segments that are parts of fields, searchable segments that are entire fields, or both. The parsing module 2034 organizes the searchable segments into a lexicon or dictionary for the event data, with the lexicon including each searchable segment (e.g., the field “src=10.10.1.1”) and a reference to the location of each occurrence of the searchable segment within the event data (e.g., the location within the event data of each occurrence of “src=10.10.1.1”). As discussed further below, the search system can use the lexicon, which is stored in an index file 2046, to find event data that matches a search query. In some implementations, segmentation can alternatively be performed by the forwarder 2026. Segmentation can also be disabled, in which case the indexer 2032 will not build a lexicon for the event data. When segmentation is disabled, the search system searches the event data directly.

Building index data structures generates the index 2038. The index 2038 is a storage data structure on a storage device (e.g., a disk drive or other physical device for storing digital data). The storage device may be a component of the computing device on which the indexer 2032 is operating (referred to herein as local storage) or may be a component of a different computing device (referred to herein as remote storage) that the indexer 2038 has access to over a network. The indexer 2032 can manage more than one index and can manage indexes of different types. For example, the indexer 2032 can manage event indexes, which impose minimal structure on stored data and can accommodate any type of data. As another example, the indexer 2032 can manage metrics indexes, which use a highly structured format to handle the higher volume and lower latency demands associated with metrics data.

The indexing module 2036 organizes files in the index 2038 in directories referred to as buckets. The files in a bucket 2044 can include raw data files, index files, and possibly also other metadata files. As used herein, “raw data” means data as when the data was produced by the data source 2002, without alteration to the format or content. As noted previously, the parsing component 2034 may add fields to event data and/or perform transformations on fields in the event data. Event data that has been altered in this way is referred to herein as enriched data. A raw data file 2048 can include enriched data, in addition to or instead of raw data. The raw data file 2048 may be compressed to reduce disk usage. An index file 2046, which may also be referred to herein as a “time-series index” or tsidx file, contains metadata that the indexer 2032 can use to search a corresponding raw data file 2048. As noted above, the metadata in the index file 2046 includes a lexicon of the event data, which associates each unique keyword in the event data with a reference to the location of event data within the raw data file 2048. The keyword data in the index file 2046 may also be referred to as an inverted index. In various implementations, the data intake and query system can use index files for other purposes, such as to store data summarizations that can be used to accelerate searches.

A bucket 2044 includes event data for a particular range of time. The indexing module 2036 arranges buckets in the index 2038 according to the age of the buckets, such that buckets for more recent ranges of time are stored in short-term storage 2040 and buckets for less recent ranges of time are stored in long-term storage 2042. Short-term storage 2040 may be faster to access while long-term storage 2042 may be slower to access. Buckets may be moves from short-term storage 2040 to long-term storage 2042 according to a configurable data retention policy, which can indicate at what point in time a bucket is old enough to be moved.

A bucket's location in short-term storage 2040 or long-term storage 2042 can also be indicated by the bucket's status. As an example, a bucket's status can be “hot,” “warm,” “cold,” “frozen,” or “thawed.” In this example, hot bucket is one to which the indexer 2032 is writing data and the bucket becomes a warm bucket when the index 2032 stops writing data to it. In this example, both hot and warm buckets reside in short-term storage 2040. Continuing this example, when a warm bucket is moved to long-term storage 2042, the bucket becomes a cold bucket. A cold bucket can become a frozen bucket after a period of time, at which point the bucket may be deleted or archived. An archived bucket cannot be searched. When an archived bucket is retrieved for searching, the bucket becomes thawed and can then be searched.

The indexing system 2020 can include more than one indexer, where a group of indexers is referred to as an index cluster. The indexers in an index cluster may also be referred to as peer nodes. In an index cluster, the indexers are configured to replicate each other's data by copying buckets from one indexer to another. The number of copies of a bucket can be configured (e.g., three copies of each bucket must exist within the cluster), and indexers to which buckets are copied may be selected to optimize distribution of data across the cluster.

A user can view the performance of the indexing system 2020 through the monitoring console 2016 provided by the user interface system 2014. Using the monitoring console 2016, the user can configure and monitor an index cluster, and see information such as disk usage by an index, volume usage by an indexer, index and volume size over time, data age, statistics for bucket types, and bucket settings, among other information.

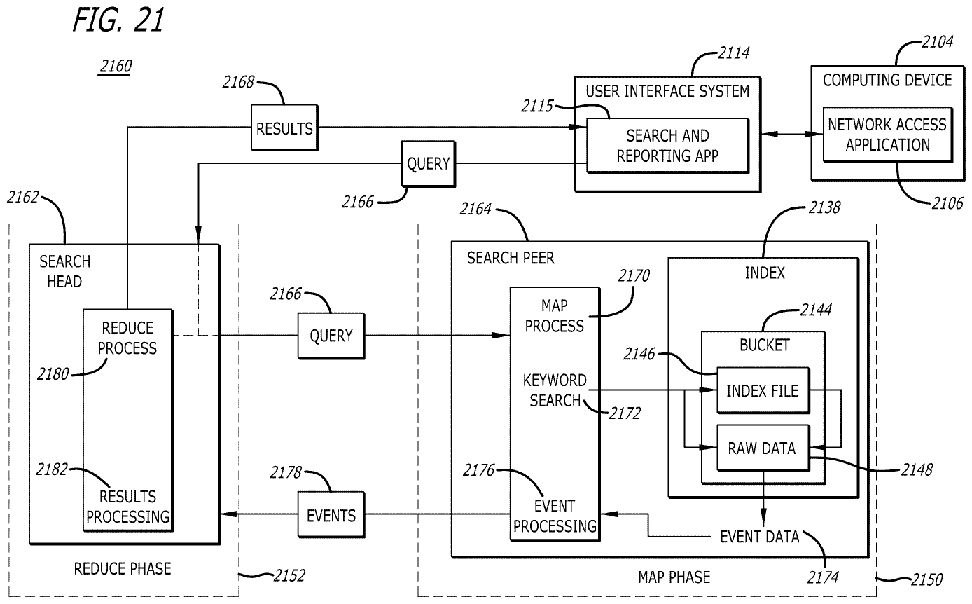

FIG. 21 is a block diagram illustrating in greater detail an example of the search system 2160 of a data intake and query system, such as the data intake and query system 1910 of FIG. 19. The search system 2160 of FIG. 21 issues a query 2166 to a search head 2162, which sends the query 2166 to a search peer 2164. Using a map process 2170, the search peer 2164 searches the appropriate index 2138 for events identified by the query 2166 and sends events 2178 so identified back to the search head 2162. Using a reduce process 2182, the search head 2162 processes the events 2178 and produces results 2168 to respond to the query 2166. The results 2168 can provide useful insights about the data stored in the index 2138. These insights can aid in the administration of information technology systems, in security analysis of information technology systems, and/or in analysis of the development environment provided by information technology systems.

The query 2166 that initiates a search is produced by a search and reporting app 2116 that is available through the user interface system 2114 of the data intake and query system. Using a network access application 2106 executing on a computing device 2104, a user can input the query 2166 into a search field provided by the search and reporting app 2116. Alternatively or additionally, the search and reporting app 2116 can include pre-configured queries or stored queries that can be activated by the user. In some cases, the search and reporting app 2116 initiates the query 2166 when the user enters the query 2166. In these cases, the query 2166 maybe referred to as an “ad-hoc” query. In some cases, the search and reporting app 2116 initiates the query 2166 based on a schedule. For example, the search and reporting app 2116 can be configured to execute the query 2166 once per hour, once per day, at a specific time, on a specific date, or at some other time that can be specified by a date, time, and/or frequency. These types of queries maybe referred to as scheduled queries.

The query 2166 is specified using a search processing language. The search processing language includes commands or search terms that the search peer 2164 will use to identify events to return in the search results 2168. The search processing language can further include commands for filtering events, extracting more information from events, evaluating fields in events, aggregating events, calculating statistics over events, organizing the results, and/or generating charts, graphs, or other visualizations, among other examples. Some search commands may have functions and arguments associated with them, which can, for example, specify how the commands operate on results and which fields to act upon. The search processing language may further include constructs that enable the query 2166 to include sequential commands, where a subsequent command may operate on the results of a prior command. As an example, sequential commands may be separated in the query 2166 by a vertical line (“|” or “pipe”) symbol.

In addition to one or more search commands, the query 2166 includes a time indicator. The time indicator limits searching to events that have timestamps described by the indicator. For example, the time indicator can indicate a specific point in time (e.g., 10:00:00 am today), in which case only events that have the point in time for their timestamp will be searched. As another example, the time indicator can indicate a range of time (e.g., the last 24 hours), in which case only events whose timestamps fall within the range of time will be searched. The time indicator can alternatively indicate all of time, in which case all events will be searched.

Processing of the search query 2166 occurs in two broad phases: a map phase 2150 and a reduce phase 2152. The map phase 2150 takes place across one or more search peers. In the map phase 2150, the search peers locate event data that matches the search terms in the search query 2166 and sorts the event data into field-value pairs. When the map phase 2150 is complete, the search peers send events that they have found to one or more search heads for the reduce phase 2152. During the reduce phase 2152, the search heads process the events through commands in the search query 2166 and aggregate the events to produce the final search results 2168.

A search head, such as the search head 2162 illustrated in FIG. 21, is a component of the search system 2160 that manages searches. The search head 2162, which may also be referred to herein as a search management component, can be implemented using program code that can be executed on a computing device. The program code for the search head 2162 can be stored on a non-transitory computer-readable medium and from this medium can be loaded or copied to the memory of a computing device. One or more hardware processors of the computing device can read the program code from the memory and execute the program code in order to implement the operations of the search head 2162.

Upon receiving the search query 2166, the search head 2162 directs the query 2166 to one or more search peers, such as the search peer 2164 illustrated in FIG. 21. “Search peer” is an alternate name for “indexer” and a search peer may be largely similar to the indexer described previously. The search peer 2164 may be referred to as a “peer node” when the search peer 2164 is part of an indexer cluster. The search peer 2164, which may also be referred to as a search execution component, can be implemented using program code that can be executed on a computing device. In some implementations, one set of program code implements both the search head 2162 and the search peer 2164 such that the search head 2162 and the search peer 2164 form one component. In some implementations, the search head 2162 is an independent piece of code that performs searching and no indexing functionality. In these implementations, the search head 2162 may be referred to as a dedicated search head.

The search head 2162 may consider multiple criteria when determining whether to send the query 2166 to the particular search peer 2164. For example, the search system 2160 may be configured to include multiple search peers that each have duplicative copies of at least some of the event data and are implanted using different hardware resources q. In this example, the sending the search query 2166 to more than one search peer allows the search system 2160 to distribute the search workload across different hardware resources. As another example, search system 2160 may include different search peers for different purposes (e.g., one has an index storing a first type of data or from a first data source while a second has an index storing a second type of data or from a second data source). In this example, the search query 2166 may specify which indexes to search, and the search head 2162 will send the query 2166 to the search peers that have those indexes.

To identify events 2178 to send back to the search head 2162, the search peer 2164 performs a map process 2170 to obtain event data 2174 from the index 2138 that is maintained by the search peer 2164. During a first phase of the map process 2170, the search peer 2164 identifies buckets that have events that are described by the time indicator in the search query 2166. As noted above, a bucket contains events whose timestamps fall within a particular range of time. For each bucket 2144 whose events can be described by the time indicator, during a second phase of the map process 2170, the search peer 2164 performs a keyword search 2174 using search terms specified in the search query 2166. The search terms can be one or more of keywords, phrases, fields, Boolean expressions, and/or comparison expressions that in combination describe events being searched for. When segmentation is enabled at index time, the search peer 2164 performs the keyword search 2172 on the bucket's index file 2146. As noted previously, the index file 2146 includes a lexicon of the searchable terms in the events stored in the bucket's raw data 2148 file. The keyword search 2172 searches the lexicon for searchable terms that correspond to one or more of the search terms in the query 2166. As also noted above, the lexicon incudes, for each searchable term, a reference to each location in the raw data 2148 file where the searchable term can be found. Thus, when the keyword search identifies a searchable term in the index file 2146 that matches a search term in the query 2166, the search peer 2164 can use the location references to extract from the raw data 2148 file the event data 2174 for each event that include the searchable term.

In cases where segmentation was disabled at index time, the search peer 2164 performs the keyword search 2172 directly on the raw data 2148 file. To search the raw data 2148, the search peer 2164 may identify searchable segments in events in a similar manner as when the data was indexed. Thus, depending on how the search peer 2164 is configured, the search peer 2164 may look at event fields and/or parts of event fields to determine whether an event matches the query 2166. Any matching events can be added to the event data 2174 read from the raw data 2148 file. The search peer 2164 can further be configured to enable segmentation at search time, so that searching of the index 2138 causes the search peer 2164 to build a lexicon in the index file 2146.

The event data 2174 obtained from the raw data 2148 file includes the full text of each event found by the keyword search 2172. During a third phase of the map process 2170, the search peer 2164 performs event processing 2176 on the event data 2174, with the steps performed being determined by the configuration of the search peer 2164 and/or commands in the search query 2166. For example, the search peer 2164 can be configured to perform field discovery and field extraction. Field discovery is a process by which the search peer 2164 identifies and extracts key-value pairs from the events in the event data 2174. The search peer 2164 can, for example, be configured to automatically extract the first 100 fields (or another number of fields) in the event data 2174 that can be identified as key-value pairs. As another example, the search peer 2164 can extract any fields explicitly mentioned in the search query 2166. The search peer 2164 can, alternatively or additionally, be configured with particular field extractions to perform.

Other examples of steps that can be performed during event processing 2176 include: field aliasing (assigning an alternate name to a field); addition of fields from lookups (adding fields from an external source to events based on existing field values in the events); associating event types with events; source type renaming (changing the name of the source type associated with particular events); and tagging (adding one or more strings of text, or a “tags” to particular events), among other examples.

The search peer 2164 sends processed events 2178 to the search head 2162, which performs a reduce process 2180. The reduce process 2180 potentially receives events from multiple search peers and performs various results processing 2182 steps on the received events. The results processing 2182 steps can include, for example, aggregating the events received from different search peers into a single set of events, deduplicating and aggregating fields discovered by different search peers, counting the number of events found, and sorting the events by timestamp (e.g., newest first or oldest first), among other examples. Results processing 2182 can further include applying commands from the search query 2166 to the events. The query 2166 can include, for example, commands for evaluating and/or manipulating fields (e.g., to generate new fields from existing fields or parse fields that have more than one value). As another example, the query 2166 can include commands for calculating statistics over the events, such as counts of the occurrences of fields, or sums, averages, ranges, and so on, of field values. As another example, the query 2166 can include commands for generating statistical values for purposes of generating charts of graphs of the events.

The reduce process 2180 outputs the events found by the search query 2166, as well as information about the events. The search head 2162 transmits the events and the information about the events as search results 2168, which are received by the search and reporting app 2116. The search and reporting app 2116 can generate visual interfaces for viewing the search results 2168. The search and reporting app 2116 can, for example, output visual interfaces for the network access application 2106 running on a computing device 2104 to generate.

The visual interfaces can include various visualizations of the search results 2168, such as tables, line or area charts, Choropleth maps, or single values. The search and reporting app 2116 can organize the visualizations into a dashboard, where the dashboard includes a panel for each visualization. A dashboard can thus include, for example, a panel listing the raw event data for the events in the search results 2168, a panel listing fields extracted at index time and/or found through field discovery along with statistics for those fields, and/or a timeline chart indicating how many events occurred at specific points in time (as indicated by the timestamps associated with each event). In various implementations, the search and reporting app 2116 can provide one or more default dashboards. Alternatively or additionally, the search and reporting app 2116 can include functionality that enables a user to configure custom dashboards.

The search and reporting app 2116 can also enable further investigation into the events in the search results 2116. The process of further investigation may be referred to as drilldown. For example, a visualization in a dashboard can include interactive elements, which, when selected, provide options for finding out more about the data being displayed by the interactive elements. To find out more, an interactive element can, for example, generate a new search that includes some of the data being displayed by the interactive element, and thus may be more focused than the initial search query 2166. As another example, an interactive element can launch a different dashboard whose panels include more detailed information about the data that is displayed by the interactive element. Other examples of actions that can be performed by interactive elements in a dashboard include opening a link, playing an audio or video file, or launching another application, among other examples.

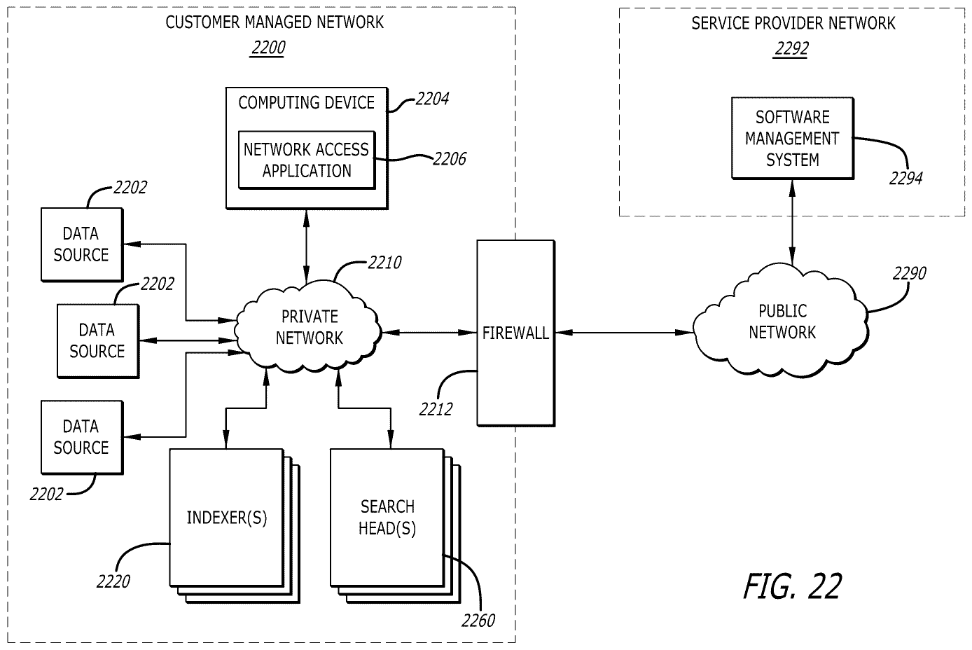

FIG. 22 illustrates an example of a self-managed network 2200 that includes a data intake and query system. “Self-managed” in this instance means that the entity that is operating the self-managed network 2200 configures, administers, maintains, and/or operates the data intake and query system using its own compute resources and people. Further, the self-managed network 2200 of this example is part of the entity's on-premises network and comprises a set of compute, memory, and networking resources that are located, for example, within the confines of an entity's data center. These resources can include software and hardware resources. The entity can, for example, be a company or enterprise, a school, government entity, or other entity. Since the self-managed network 2200 is located within the customer's on-prem environment, such as in the entity's data center, the operation and management of the self-managed network 2200, including of the resources in the self-managed network 2200, is under the control of the entity. For example, administrative personnel of the entity have complete access to and control over the configuration, management, and security of the self-managed network 2200 and its resources.

The self-managed network 2200 can execute one or more instances of the data intake and query system. An instance of the data intake and query system may be executed by one or more computing devices that are part of the self-managed network 2200. A data intake and query system instance can comprise an indexing system and a search system, where the indexing system includes one or more indexers 2220 and the search system includes one or more search heads 2260.

As depicted in FIG. 22, the self-managed network 2200 can include one or more data sources 2202. Data received from these data sources may be processed by an instance of the data intake and query system within self-managed network 2200. The data sources 2202 and the data intake and query system instance can be communicatively coupled to each other via a private network 2210.

Users associated with the entity can interact with and avail themselves of the functions performed by a data intake and query system instance using computing devices. As depicted in FIG. 22, a computing device 2204 can execute a network access application 2206 (e.g., a web browser), that can communicate with the data intake and query system instance and with data sources 2202 via the private network 2210. Using the computing device 2204, a user can perform various operations with respect to the data intake and query system, such as management and administration of the data intake and query system, generation of knowledge objects, and other functions. Results generated from processing performed by the data intake and query system instance may be communicated to the computing device 2204 and output to the user via an output system (e.g., a screen) of the computing device 2204.

The self-managed network 2200 can also be connected to other networks that are outside the entity's on-premises environment/network, such as networks outside the entity's data center. Connectivity to these other external networks is controlled and regulated through one or more layers of security provided by the self-managed network 2200. One or more of these security layers can be implemented using firewalls 2212. The firewalls 2212 form a layer of security around the self-managed network 2200 and regulate the transmission of traffic from the self-managed network 2200 to the other networks and from these other networks to the self-managed network 2200.

Networks external to the self-managed network can include various types of networks including public networks 2290, other private networks, and/or cloud networks provided by one or more cloud service providers. An example of a public network 2290 is the Internet. In the example depicted in FIG. 22, the self-managed network 2200 is connected to a service provider network 2292 provided by a cloud service provider via the public network 2290.

In some implementations, resources provided by a cloud service provider may be used to facilitate the configuration and management of resources within the self-managed network 2200. For example, configuration and management of a data intake and query system instance in the self-managed network 2200 may be facilitated by a software management system 2294 operating in the service provider network 2292. There are various ways in which the software management system 2294 can facilitate the configuration and management of a data intake and query system instance within the self-managed network 2200. As one example, the software management system 2294 may facilitate the download of software including software updates for the data intake and query system. In this example, the software management system 2294 may store information indicative of the versions of the various data intake and query system instances present in the self-managed network 2200. When a software patch or upgrade is available for an instance, the software management system 2294 may inform the self-managed network 2200 of the patch or upgrade. This can be done via messages communicated from the software management system 2294 to the self-managed network 2200.

The software management system 2294 may also provide simplified ways for the patches and/or upgrades to be downloaded and applied to the self-managed network 2200. For example, a message communicated from the software management system 2294 to the self-managed network 2200 regarding a software upgrade may include a Uniform Resource Identifier (URI) that can be used by a system administrator of the self-managed network 2200 to download the upgrade to the self-managed network 2200. In this manner, management resources provided by a cloud service provider using the service provider network 2292 and which are located outside the self-managed network 2200 can be used to facilitate the configuration and management of one or more resources within the entity's on-prem environment. In some implementations, the download of the upgrades and patches may be automated, whereby the software management system 2294 is authorized to, upon determining that a patch is applicable to a data intake and query system instance inside the self-managed network 2200, automatically communicate the upgrade or patch to self-managed network 2200 and cause it to be installed within self-managed network 2200.

Various examples and possible implementations have been described above, which recite certain features and/or functions. Although these examples and implementations have been described in language specific to structural features and/or functions, it is understood that the subject matter defined in the appended claims is not necessarily limited to the specific features or functions described above. Rather, the specific features and functions described above are disclosed as examples of implementing the claims, and other equivalent features and acts are intended to be within the scope of the claims. Further, any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Processing of the various components of systems illustrated herein can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Examples have been described with reference to flow chart illustrations and/or block diagrams of methods, apparatus (systems), and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to perform a computer-implemented method such that the instructions which execute on the computing device or other programmable apparatus provide steps for implementing the acts specified in the flow chart and/or block diagram block or blocks.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A computer-implemented method, comprising:
receiving user input corresponding to a question to be evaluated by a large language model (LLM), wherein the user input is received by a graphical user interface (GUI) of a network device of a user;
obtaining contextual metadata from content displayed on a display screen of the network device;
generating a prompt for the LLM from the user input and the contextual metadata;
providing the prompt to the LLM;
receiving a response from the LLM; and
displaying an answer to the question included in the user input in the GUI of the network device of the user.

2. The computer-implemented method of claim 1, wherein the GUI is a chatbot interface configured to display interactions between the user and the LLM via a chat interface.

3. The computer-implemented method of claim 1, wherein the display screen of the network device displays a web browser application, and the contextual metadata includes a uniform resource locator (URL) displayed in the web browser application.

4. The computer-implemented method of claim 1, wherein generating the prompt for the LLM includes combining the question included in the user input with the contextual metadata.

5. The computer-implemented method of claim 4, wherein the contextual metadata is appended to the question in the user input.

6. The computer-implemented method of claim 1, wherein the contextual metadata adds contextual information to the question included in the user input resulting in the LLM obtaining an understanding of an aspect of a network environment of the user to which the question pertains.

7. The computer-implemented method of claim 1, wherein the contextual metadata represents one or more of: (i) one or more filters of data of a network environment of the user, or (ii) one or more time restrictions.

8. A computing device, comprising:
a processor; and
a non-transitory computer-readable medium having stored thereon instructions that, when executed by the processor, cause the processor to perform operations including:
receiving user input corresponding to a question to be evaluated by a large language model (LLM), wherein the user input is received by a graphical user interface (GUI) of a network device of a user,
obtaining contextual metadata from content displayed on a display screen of the network device,
generating a prompt for the LLM from the user input and the contextual metadata;
providing the prompt to the LLM,
receiving a response from the LLM, and
displaying an answer to the question included in the user input in the GUI of the network device of the user.

9. The computing device of claim 8, wherein the GUI is a chatbot interface configured to display interactions between the user and the LLM via a chat interface.

10. The computing device of claim 8, wherein the display screen of the network device displays a web browser application, and the contextual metadata includes a uniform resource locator (URL) displayed in the web browser application.

11. The computing device of claim 8, wherein generating the prompt for the LLM includes combining the question included in the user input with the contextual metadata.

12. The computing device of claim 11, wherein the contextual metadata is appended to the question in the user input.

13. The computing device of claim 8, wherein the contextual metadata adds contextual information to the question included in the user input resulting in the LLM obtaining an understanding of an aspect of a networking environment of the user to which the question pertains.

14. The computing device of claim 8, wherein the contextual metadata represents one or more of: (i) one or more filters of data of a networking environment of the user, or (ii) one or more time restrictions.

15. A non-transitory computer-readable medium having stored thereon instructions that, when executed by one or more processors, cause the one or more processors to perform operations including:
receiving user input corresponding to a question to be evaluated by a large language model (LLM), wherein the user input is received by a graphical user interface (GUI) of a network device of a user;
obtaining contextual metadata from content displayed on a display screen of the network device;
generating a prompt for the LLM from the user input and the contextual metadata;
providing the prompt to the LLM;
receiving a response from the LLM; and
displaying an answer to the question included in the user input in the GUI of the network device of the user.

16. The non-transitory computer-readable medium of claim 15, wherein the GUI is a chatbot interface configured to display interactions between the user and the LLM via a chat interface.

17. The non-transitory computer-readable medium of claim 15, wherein the display screen of the network device displays a web browser application, and the contextual metadata includes a uniform resource locator (URL) displayed in the web browser application.

18. The non-transitory computer-readable medium of claim 15, wherein generating the prompt for the LLM includes combining the question included in the user input with the contextual metadata includes appending the contextual metadata to the question in the user input.

19. The non-transitory computer-readable medium of claim 15, wherein the contextual metadata adds contextual information to the question included in the user input resulting in the LLM obtaining an understanding of an aspect of a network environment of the user to which the question pertains.

20. The non-transitory computer-readable medium of claim 15, wherein the contextual metadata represents one or more of: (i) one or more filters of data of a network environment of the user, or (ii) one or more time restrictions.
